(19) United States
(12) Patent Application Publication
(10) Pub. No.: US 2017/0364599 A1
(43) Pub. Date: Dec. 21, 2017

(54) APPLICATION FOR ENHANCING METADATA TAG USES FOR SOCIAL INTERACTION

(71) Applicant: INFIELDS, LLC., Washington, DC (US)

(72) Inventors: Chiedo Raymond OHANYERENWA, Washington, DC (US); James Lowell Ramsey CLARKE, Washington, DC (US)

(73) Assignee: INFIELDS, LLC., Washington, DC (US)

(21) Appl. No.: 15/625,441

(22) Filed: Jun. 16, 2017

Related U.S. Application Data
(60) Provisional application No. 62/351,545, filed on Jun. 17, 2016.

(51) Int. Cl. G06F 17/30; H04L 12/58; H04L 29/08; G06F 3/0482

(52) U.S. Cl. CPC G06F 17/30867; H04L 67/2804; H04L 51/32; G06F 17/30604; G06F 17/3005; G06F 17/30038; G06F 17/30029; G06F 3/0482

(57) ABSTRACT

There is provided a device and a method to facilitate enhanced communication between social entities utilizing metadata tags, which may be hashtags. According the features of the device and the method, users may select to follow other users and hashtags in order to see posts related to those hashtags from users they follow on their timeline or their following tab and communicate further with their followers or the poster using enabled functions such as creating and viewing clips related to said posts, sending and receiving wires in relation to a particular post or creating emoji streams and sharing publically or amongst selected friends. Users may tag one another to posts, send direct or reply wires or engage with one another across this social networking platform in any number of ways utilizing enhanced potential of social entities such as hashtags, which have gone previously untapped. This redefined computing architecture allows for quicker processing and more efficient and use of computing resources.

### CROSS-REFERENCE TO RELATED APPLICATION

This application claims priority from Provisional Application No. 62/351,545, filed on Jun. 17, 2016 in the United States Patent Office, the disclosure of which is incorporated herein by reference in its entirety.

### BACKGROUND

The present disclosure relates to social networking, particularly involving the use of hashtags [#]. A hashtag is a word or phrase preceded by a number sign (#), used within a message to mark or identify a keyword or topic of interest and facilitate a search for it. While social networks have long utilized hashtags for sorting of keywords and phrases within posts, grouping related posts sharing the same exact hashtag entered by users or loosely monitor trends due to repetition, the current field of social networking platform have failed to utilize hashtags to their full potential by effectively organizing hashtags in order to establish permanent or temporary relationships between social entities. The related art platforms available for hashtag searching allow for searches and historical data of hashtag usage to be compiled but do not establish permanent relationships between users to facilitate a more efficient use of computer resources, nor do they allow for direct communication about posts and their attachments with the hashtag as the basis. The present disclosure seeks to remedy the situation.

The benefits of a social networking platform that efficiently and effectively establishes relationships between social entities utilizing hashtags are plentiful. Not only would this allow users to more easily follow their favorite groups, activities and other users, they would also be able to quickly monitor the trends they are interested at regular intervals, share rate and interact based on content related to the hashtags they desire to interact with and ergonomically facilitate communication between groups associated with differing hashtags in a way that hasn't been done before. Such a platform would help users to efficiently limit the use of bandwidth as well as server memory usage, by effectively limiting the scope of hashtag related searches to more specific content they wish to see, such as that posted by their friends and associates to said hashtag. Such a platform would also be capable of facilitating better communication between celebrities and their fans, commercial entities and interested consumers and networks of skilled users.

### SUMMARY

The present disclosure concerns a social networking platform and describes systems and techniques to enhance communication and social networking through the use of hashtags and related metadata tags utilizing a demarcation symbol. In some exemplary embodiments of the present disclosure, said demarcation symbol is a pound sign (#) used to create a hashtag, in other exemplary embodiments the symbol may be represented by other forms, including but not limited to parentheticals (%), emoticons, images, or other symbols. Described herein are methods and apparatuses performed by one or more processing devices, which includes receiving, processing, extracting, determining and outputting code in the form of posts and associated data related to the aforementioned hashtags or metadata tags.

Within the social networking platform posts may be created and assigned to any number of hashtags or metadata tags by the social networking platform user selecting media to be extracted and processed from their mobile device, camera or another social media platform (such as Twitter or Instagram) and output in the form of a post. In all exemplary embodiments of the present disclosure posts may be created by users. In some exemplary embodiments the user will have the option of creating a public post or a private post. In some exemplary embodiments a public post may be visible to all users who view the posting user's profile, so long as the posts was made to a public social entity. In other exemplary embodiments a public post will be visible when a user conducts a search for any one of the social entities it's posted to so long as the user who posted it has a public profile, or the searching user is following the user who posted it.

In some exemplary embodiments of the present disclosure private posts will only be visible to users viewing the posting user's profile if the viewing users are following the social entities, in this case hashtags, that the posts are posted to and the poster is a public user. In other exemplary embodiments if the posting user is private the aforementioned rules apply to private post visibility only if the viewing user is an accepted follower of the posting user. In other exemplary embodiments a private post will be visible when a user conducts a search for any one of the social entities it's posted to so long as the user who posted it has a public profile, and the searching user is following the posting user, however the other social entities the post is posted to may not be visible in some exemplary embodiments. In other exemplary embodiments a private post will be visible when a user conducts a search for any of the private social entities another user posted them to only if the searching user is accepted as a follower of that private social entity and the searching user is following the posting user.

In some exemplary embodiments users may also have a following tab which will display any posts to any hashtags the user is following if posted by another user the former user is following. In other exemplary embodiments users may possess a timeline which allows said user to select a set plurality of social entities, the posts to which will be displayed on their timeline.

In some exemplary embodiments the timeline displayed posts will only be selected from users the viewing user follows. In other exemplary embodiments the timeline may show certain public posts from public users the viewing user does not follow. In yet other exemplary embodiments the viewing user may have the option to select whether they wish to see posts only from users they are following on their timeline or instead to also see public posts from public users they do not follow. And in other exemplary embodiments some of the aforementioned exemplary embodiments will be enhanced features to the social networking platform disclosed, requiring a transaction including but not limited to options such as financial transactions or a form of token exchange.

The present disclosure seeks to enable individuals of ordinary skill in the art to create, understand or modify a social networking platform user interface with similar relationships between users, hashtags and content related to other users and hashtags including but not limited to clips, wires and posts. As compared with the related art in the field such efficient communication limits the use of resources on users and processor alike by reducing the sheer amount of data that must be collected since users are able to conduct automated and efficient searches of connected users' posts rather than having to search throughout the entire social network for all posts related to a particular hashtag every time. An added technical benefit is the limited amount of bandwidth that would need to be utilized for a more limited search. Ultimately the data would occupy less memory on the application server than that of its contemporary rivals.

Users may also communicate directly from posts and create attachments to posts effectively as clips based on a computer code architecture that creates pathways direct from hashtag to post to attachment or message, which has not been used before. For instance, in a related art system, when a user desires to share a post or re-post a clip or other material, the user would have to request the terminal device to generate a chat text entry box or message entry box (which displays or other material data entered by the keyboard or other input method) insert the desired clip or other material into the created chat entry box to be reposted. Thereafter, the reposted message would be displayed corresponding to a message screen of the user. Here, since the entire clip or material has to be reposted, computer resources (i.e., processors, memory, network bandwidth, etc.) required for the processing would be proportionally increased based on the size of the clip or other material to be reposted. On the other hand, in the present exemplary embodiment of the disclosure, a user can create a hashtag on the post itself, and as a result, a direct connection (or link) is created between the post and another user (designated to receive the post). Since the features of the present exemplary embodiment eliminates the need for processing the entire reposted data, the computer resources of the related art system is reduced.

The general architecture of other social media platforms has been for hashtags to be a mere attachment to a post and not a post being attached to the hashtag or multiple hashtags. The disclosed application therefore allows for streamlined interactions without taxing processing resources to the same degree existing platforms would be required to achieve the same functionality with their current architecture. There may further exist other interactions between social entities within the spirit of the disclosure not explicitly described herein.

### BRIEF DESCRIPTION OF THE DRAWINGS

The accompanying drawings which are incorporated in and form a part of the specification, illustrate several exemplary embodiments of the disclosure wherein:

FIG. 1 depicts a networked computer system relating users of the interface social network application to one another and a storage database using the internet.

FIGS. 2A and 2B represent graphical user interfaces in which a user may view a “Timeline” of the social network application displaying associated users' various posts and related data over time.

FIG. 3 depicts a graphical user interface in which a user may view the clips of associated users related to a particular post of the social network application, displaying which posts were made by their followers and related data.

FIG. 4 depicts a Timeline selection tool's graphical user interface, in which a user may search for and select which social entities to display on her timeline

FIG. 5 depicts a “Following” tab's graphical user interface, in which a user may view posts from their followers that are not displayed on their timeline, in thumbnail format with indications of the user who posted, the social entity posted to, if the post is a video or photo, and if the user has received any wires or clips on each post.

FIG. 6 displays a graphical user interface in an exemplary embodiment of the social networking application's search tool, where a user may search for, view the profiles of and select to follow other users of the application.

FIG. 7 represents a graphical user interface in an exemplary embodiment of the social networking application's search tool, where a user may search for, view some posts made to and select to follow social entities within the application.

FIG. 8 depicts a graphical user interface under the camera tool of the social networking application, which allows a user to take a picture or video using their mobile device, upload a picture or video saved to their mobile device, or pull a post from another social platform.

FIG. 9 displays a graphical user interface under the Activity tool of the social networking application, which allows a user to view the requests of others, their own activity, and take action related to any requests.

FIG. 10 represents a graphical user interface for the Profile tool of the social networking application, which allows a user to see his profile, his related data, and thumbnails of any posts made.

FIG. 11 depicts the interoperability of pulling posts from other social platforms through the social networking application, using the pulled posts menu to select an application to pull posts from, a connection to said applications through the internet, the populating of a database with information from said applications and the display of populated data into the user interface.

FIG. 12 depicts the interoperability of an exemplary embodiment of the social networking application's following tool in conjunction with the timeline tool, such that selections on the timeline tab will not be posted to the following tab, and the selections in this exemplary embodiment for the timeline tab must be made from a subset of selections in the following tool.

FIG. 13 illustrates an exemplary embodiment of displaying the 1-touch theme change ability of the preset disclosures.

FIG. 14 is a zoomed out view of a User Interface 1400 of a wall 1402 for a post 1406, surrounded by multiple wall comments according to an exemplary embodiment.

FIG. 15 is a zoomed out view of a User Interface 1500 for a wall from the post creators perspective according to an exemplary embodiment.

FIG. 16 is a flowchart showing the method of creating a post and assigning its hashtag and visibility options.

FIG. 17 is a flowchart showing the method of creating a wire and assigning its hashtag and a user to send the wire according to an exemplary embodiment.

FIGS. 18A-G illustrated a method for creating a post directly from a camera function of the user device according to an exemplary embodiment.

FIG. 19 is a flowchart showing the method of creating a clip, setting its visibility and possibly assigning it to a hashtag according to an exemplary embodiment

FIG. 20 is a flowchart displaying how the application user interface and server interact to make certain wires visible to the viewing user according to an exemplary embodiment

FIG. 21 is a flowchart displaying how the application user interface and server interact to make certain clips visible to the viewing user according to an exemplary embodiment.

FIG. 22 is a flowchart displaying how the application emoji streams may be created by the application user interface and server interacting to send emoji streams from one user to another according to an exemplary embodiment.

FIG. 23 is a flowchart displaying how the application emoji streams may be created according to an exemplary embodiment.

### DETAILED DESCRIPTION OF THE INVENTION

Social entities are identifiers created with a prefix symbol. In most of the exemplary embodiments of the present disclosure this prefix symbol is a number sign, the identifier is the subsequent text, and the social entity is represented by creation of a hashtag formed by the two yet separated from what is outside of the hashtag by a space. However social entities where an emoticon or other picture follows a number sign or another symbol is used in lieu of the number sign, including but not limited to an exclamation-mark, at-sign, dollar-sign, chinese-character, ampersand or where the symbol is not a prefix but a suffix or at any point connected to the identifier are within the spirit of the disclosure when used and interacted with in the manner described below. Social entities can be created to represent concrete entities such as brands, campaigns, and people (for example #popefrancis or Toyota#thon) or social entities can be created to represent abstract ideas such as visions of an unreachable destination or future people or events (such as @utopia or apocalypse#). In this exemplary embodiment social entities may be created by users, facilitators of the social networking platform (which may also be referred to as “application”) or a computer algorithm. It is envisioned that users may be individuals, corporations or groups of individuals (such as a sports team, band, or other collectives). Facilitators would be administrators, moderators or other controlling/monitoring personnel affiliated with the application. A computer algorithm may be one or any number of programs or artificial intelligence bots designed to monitor trends within the platform or other social networking platforms in order to create, rank or otherwise interact with social entities accordingly.

Social entities (which may also be referred to as hashtags or metadata tags) can be created by a first party user inputting a command on a computing or mobile device which transmits the request to create a public, private, personal or related hashtag or metadata tag which may be interacted with by any second party users that choose to follow it, as well as the first party user/hashtag creator. Users may establish connections to metadata tags representing public or private groups, personal ideas, or personal and public campaigns by inputting into their computing device a request to follow said metadata tags. This request will be received by a processing device which updates the system database to indicate that a follow relationship has been established between the requesting user and the metadata tag such that all content related to said metadata tag will be visible to said user if posted by a public user or a private user that the requesting user follows. In this embodiment, public, private, and personal hashtags will be defined as followed below. Other exemplary embodiments may define public, private, and personal hashtags similarly or differently.

As described in the above exemplary embodiments a public hashtag is a hashtag that is accessible by any user. A user can establish a predefined relationship with the hashtag by means including but not limited to inputting a command into their computing device to search for the hashtag and requesting to follow the hashtag when found, clicking a link related to said hashtag (such as in another post or a user profile) and requesting to follow the hashtag, or responding in the affirmative to a request to follow said hashtag that is sent by another user to their computing device. In some exemplary embodiments where a public hashtag has been created, posts related to said hashtag may be observed by any user who searches for said hashtag. In other exemplary embodiments if a user follows a public hashtag they may see posts from any other user made to that hashtag. In separate exemplary embodiments if a user follows another user who posts to a public hashtag, the former user may see posts by the latter user on their timeline. In yet other exemplary embodiments, if a user follows another user who posts to a public hashtag, the former user would only see posts from the latter user and only such similar users who they follow, when they do a search for said hashtag. In some exemplary embodiments a search may be facilitated through means including but not limited to clicking on a hashtag when it is seen in a post or message, entering the name of the hashtag into a search field or clicking on a suggestion made by the platform's algorithm perhaps when searching for related terms.

A private hashtag is a hashtag that is not accessible by any user. A user can establish a predefined relationship with the hashtag by means including but not limited to inputting a command into their computing device to search for the hashtag and requesting to follow the hashtag when found, clicking a link related to said hashtag (such as in another post or a user profile) and requesting to follow the hashtag, or responding in the affirmative to a request to follow said hashtag that is sent by another user to their computing device. In some exemplary embodiments where a private hashtag has been created, posts related to said hashtag may be observed by any user who searches for said hashtag and is following a public user who posts to said private hashtag. In such exemplary embodiments the former user would only see the posts created by the latter user to said hashtag and such similar public users who they follow. In other exemplary embodiments if a user follows a private hashtag they may see posts from any public user made to that hashtag. In separate exemplary embodiments if a user follows a private user who posts to a private hashtag, the former user may see posts by the latter user on their timeline.

A personal hashtag is a hashtag that belongs to a user or users permanently or temporarily. A user can establish a predefined relationship with the hashtag. In some exemplary embodiments, any number of users can follow a personal hashtag, but only the current owner may post to it. In other exemplary embodiments the aforementioned rules may apply and ownership of a hashtag may be purchased on a permanent or temporary basis through means including but not limited to inputting purchasing information into a computing device to be transferred into an encrypted database, being processed, and transmitting confirmation that the transaction has been processed via the use of a system tokens, financial transaction, or other devise. In some exemplary embodiments tokens may be paid for by users of the social networking platform. In other exemplary embodiments tokens may be generated over time, or based on any number of user activities including but not limited to the number of posts a user has, the number of likes a user's created posts or clips have or the number of advertisements a user views. In yet other exemplary embodiments, users may share tokens by means including but not limited to trading tokens, gifting tokens or purchasing tokens from other users in exchange for some bargained for detriment. In even other exemplary embodiments a combination of all aforementioned token transactions may occur.

An example of another social entity would be a fusion of the aforementioned hashtags, or an overarching metadata-tag which is permanently associated with all users by default. An example of this would be if the application is called Inroads and all users have a follow relationship established with #Inroads such that they may create and view posts directed to #Inroads without first having to search and establish such a follow relationship. This could be useful in helping to make the application ergonomic for new users, enhancing communication between all users and allowing for a more public form of communication where convenient.

Relationship Networks are created by a user utilizing a computing device to select relationship options for content within the application, said computing device sending the selected relationships and content to a database where it is sorted, processed and presented to the user via the computing device's audio-visual display, thereby establishing relationships between any number of users, social entities and objects. Objects may include content including but not limited to posts, clips, wires, media and tags. In this embodiment, a relationship network is created by users establishing a relationship. In one exemplary embodiment this relationship may be a Follow relationship, with other users for example. When the Follow relationship is established by a user, the user is then following the other user. The user's Follow relationship with the other user will determine the user's access to different objects, features, and functions created by or associated with the other user.

Also in this embodiment, a network is created by users establishing a relationship, in this exemplary embodiment a Follow relationship, with a social entity. In some exemplary embodiments, the social entity is a hashtag. When the Follow relationship is established by a user inputting a command into a computing device that is transmitted to a database for processing by a processing device, the user is then following the hashtag. The user's Follow relationship with the hashtag will determine the user's access to different objects, features, and functions associated with the hashtag.

In some exemplary embodiments the establishment of a relationship may be purely at the discretion of the user. This may include but is not limited to a user's choice to follow a public user, a public hashtag or to establish a relationship with a post. In other exemplary embodiments the establishment of a relationship may be at the discretion of another user as well. One example of this might be a second party user approving the first party user's choice to follow the second party user's private account. Another example would be a second party user approving the first party user's choice to follow the second party user's private hashtag. Yet another example might include the second party user tagging the first party user to a post, clip or other content generated by the latter user.

Other exemplary embodiments may include computing devices, database and processing systems where users can input commands into said computing devices and have said commands transferred and processed in a database to establish other relationships with users of other computing devices, social entities created by other users, or content created by other users (for example the ability of a user to establish a relationship with a post by inputting a command into the computing device for processing including but not limited to establishing Like, Dislike, and Support relationships. For example, in a different embodiment, users may create two relationships with a hashtag by clicking selectable symbols on the audio/visual user interface display of the computing device for Follow and Support, thereby inputting a command into the computing device which is sent to via the devices internal modem to a server where it is received and processed via hashtag network software into a database for storage. In yet another embodiment, users may similarly possess two relationships with other users, Follow and Like, while also having three relationships with a hashtag, Follow, Like, and Support. In yet other exemplary embodiments, users may have two relationships with content, Like and Dislike, while having three relationships with other users, Follow, Like and Support, while also having four relationships with a hashtag, Follow, Like, Love and Support.

The user's establishment of a relationship with another user or with a social entity may determine the user's access to different objects, features, and functions associated with the other user or social entity. In some exemplary embodiments this may be limited to followers of both a user and a particular hashtag being allowed to see posts they otherwise would not, generated by the user to the particular hashtag. In other exemplary embodiments liking or loving a particular hashtag or user may give way to specialized content including but not limited to hidden clips, posts, or prizes such as tokens or real world prizes. For example, a dealership could create a promotion offering a car to one of the first million users to like their hashtag within the social networking platform. It is envisioned within the scope of this disclosure that a computer generated algorithm within the application's server or database would process the request to establish the promotion from the dealership's computing device, process and transmit the promotion to the mobile computing devices of receiving users, and determine a user from the first million receiving users to select they like the hashtag on their user interfaces subsequent to the start of the promotion, at the moment the hashtag reaches a million likes, and post the name of the user in a way to assist both the winning user and the dealership user with establishing a contract with one another.

A post is a media file that is created and shared by a user. A user may create a post by selecting a post creation icon on the toggle bar of their user interface and selecting from a variety of content to post, including but not limited to content stored within the ram of their mobile device such as saved media, content they have posted to other social networking platforms as processed via their mobile devices modem through the internet, or content they utilize their mobile device's camera to take a live picture or video of. This request to post is then processed by the receiving server and established on the application database as relating to any number of hashtags selected by the user in their interface, or by default. A post has features that a user customizes when creating a post and functions that will allow users to interact with the post after the post is shared. In this embodiment, a post may contain one or more of the following features: a Media file, Assigned Hashtag(s) (or metadata tags), a Privacy Setting, a Caption, Tagged User(s), a Save Option, Wire(s), and Clip(s).

Media is a photo, video, or other audio-visual file. In some exemplary embodiments a user can create new media or upload the photo, video, or other audio-visual file by means of selecting to create a post or a clip in their user interface, said request being transmitted to the application server for processing. In other exemplary embodiments users will also be able to Pull media from other social media platforms and post it the social networking platform described in the present disclosure. In yet other exemplary embodiments the presently described social networking platform may conduct live searches of other social media platforms for particular social entities to repost it to the presently described social networking platform. For example, a user may input commands into the user interface for the mobile device to send a signal through the internet that links the application server for their account on the present social networking platform with the application server for their account on another social media platform. The present social networking platform's processing device may search for a particular hashtag in the other social media platform and process the data such that any time the user posts media with that hashtag on another social media platform, the post is captured and the media content pulled or effectively reposted within the present social networking platform either with or without the caption.

Assigned Hashtags (or metadata tags) are social entities that a post can be assigned to. A post may be assigned to a hashtag by a user utilizing the social networking platform's user interface to select any number check box from a list of hashtags while creating a post, causing the mobile device to transmit a signal to the server via the internet that is processed by the server processor to establish a relationship between the post and the selected hashtags in the application's database. In some exemplary embodiments each post must be assigned to one or more hashtags. Hashtags can take variety of forms including but not limited to Public, Private, Personal, or a combination of the three. Assigning a post to a hashtag or number of hashtags is not being done in contemporary social networking platforms. Rather hashtags are assigned and associated with posts. This change in architecture allows posts to be more quickly sorted according to hashtags and creates a faster and more efficient ability to search for posts by hashtags, or hashtags related to particular users, and facilitates the sharing related data. Allowing posts to be assigned to multiple hashtags allows users greater flexibility in making their post quickly visible to a more narrowly selected audience. Ultimately this limits the drain on computing resources by lowering the amount of bandwidth that would be necessary to conduct the same type of searches based on hashtags when all data is presorted by hashtag. This also lowers the amount of memory that is occupied within the application for such automated searches as searches are narrowly tailored based on both hashtag and pre-established friend relationships. Additionally, by sorting the posts and metadata tags in such an organized fashion, this architecture should improve processing speed, keeping both manual and automated database queries both fast and efficient in comparison with the related art. A re-structuring of the database and indexes is within the scope of the disclosed application and automated limits may be placed on the data to keep it operating optimally, such as limiting posts clips and wires by means including but not limited to quantity or time. Finally, this restructuring allows for interactions conceived within the scope of the presently disclosed application that would not have been otherwise functionally conceivable, including but not limited to user created hashtags serving as public or private servers, posts serving as effective chatrooms to those servers where wires may be sent to different combinations of users, clips being attached to those posts by groups as defined by the posting user, and the ability for computer processors, moderators and administrators of the application to quickly and efficiently record statistical information related to said hashtags, including but not limited to post count and users following, because unlike with related art applications, this information has been presorted at the time of post creation or is established permanently (barring manual cancellation by the user) at the time a user chooses to follow a hashtag respectively.

A Privacy Setting is a setting that determines a user's interaction with functions and features of the post. In some exemplary embodiments, the Privacy Setting may be selected by a user in their interface as either Public or Private, causing the mobile device to send a signal to the application server which processes and stores the selected setting in the application database. Other exemplary embodiments may include additional Privacy Settings including but not limited to a Follower Privacy Setting that allows a user to select which users or groups of users (such as all followers of a particular hashtag) should have access to their posts as if they were a public user, or a Hidden Privacy Setting that allows a user's profile to remain hidden, such that other users would not see their profile to request to follow it unless the hidden user requests to follow them first.

A Caption is text that a user can include in the post. In some exemplary embodiments users can mention other social entities or users in the captions as well for enhanced interaction different from if they had tagged the user or posted the post to the hashtag. Some examples of this enhanced interaction could include but are not limited to a user typing a hashtag in the user interface's caption of a post they are creating, the text for which is sent to a server for processing which distinguishes that part of the text as a hashtag, sending it to the database as such and automatically creating a link to a mentioned hashtag. Similarly, a tagging feature could be utilized by one user to mention another user, a notice being sent from the application server to the mobile device of the mentioned user or any of the poster's followers following the mentioned hashtag that the user or hashtag was mentioned respectively or any combination of the four.

A Tagged User is a user that is tagged in a post and inherits access to all of the features granted to tagged users in a post as explained in the Tagged Users module. A user is tagged when another user selects the former within their user interface in creating a post, thereby sending a signal from their mobile device to the application server to process the latter user as tagged

A Save Option is a function that allows users to save the location of the post. In some exemplary embodiments once the location of a post is saved, the user who saved it can reference it more quickly. In other exemplary embodiments the post may appear in the user who input a command in their user interface to save the post, causing the mobile device to send a signal to the application server to process and sort the post in the database to the user's profile under a tab for saved posts. In yet other exemplary embodiments the saved post may be interacted on by the saving user inputting commands into their user interface in enhanced ways including but not limited to the user now being able to send clips and wires to their followers that they wouldn't otherwise, from the saved post.

Wires are text and media that is created by a user inputting commands in their user interface by selecting a post, selecting a type of wire to create (including but not limited to text, audio, or video) and selecting from a variety of options of where to send it including but not limited to another user, a hashtag or a group of users. These commands are sent from the wire creating user's mobile device to the application server via the internet for processing, sorted appropriately in the database to be assigned for viewing by the selected receiving user or users associated with the selected hashtag and sent to said user(s) mobile devices following processing by the application server. Wires are sent direct to a user or users as selected by the wire creator. In some exemplary embodiments the users that the wire creator can select are limited to their own followers. In other exemplary embodiments the users the wire creator can select are limited to their own followers who could otherwise see the post. In yet other exemplary embodiments wires may be reply wires that are limited any number of the users copied on the original wire the responsive user received.

Clips are text and media that is created by a user inputting commands in their user interface by selecting a post to attach the clip to, selecting a type of clip to create (including but not limited to audio or video) and selecting from a variety of options of where to send it including but not limited to followers, public or private. In some exemplary embodiments clips may be public or private. In other exemplary embodiments public clips would be visible to users under a clips tab within the post and a ‘following sub-tab’ for clips from users the former user is following, and a ‘not-following sub-tab’ for clips from users the former user is not following. In yet other exemplary embodiments private clips from latter users the former user is following would be visible to users under a clips tab within the post and only under a ‘following sub-tab’, whereas private clips from users the former user is not following would not be visible to them at all. In other exemplary embodiments the visibility of the clips may depend on whether the user posting said clips posted them publically or privately, whether the user who posted the clips is a public or private user and whether the former user was tagged in the post or the clip or not.

A Hashtag Mention is a notification/alert to users sent from the post by a user inputting a command in their user interface in a way that mentions a hashtag or metadata tag (such as user Dracula typing a caption “I like to suck #blood” on their post, serving as a mention of #blood), said command being sent from their mobile device via the internet to the application server for processing, and being sent to the mobile devices of users following the mentioning user and the hashtag after being sorted and processed in the database. In some exemplary embodiments the creator of a post or a clip can select which hashtag to mention from a list just as the creator would when mentioning a user. In other exemplary embodiments it may be enough to include the hashtag in the caption of the post. In yet other exemplary embodiments mentioning a user and a hashtag in conjunction may send a notice to all followers of the user also following the particular hashtag of the mention.

Posts are shared among users in the network. Users view the post and interact with the post through several features within the post. In some exemplary embodiments, a user can share the post with followers by entering a sequence in their user interface to create a post in their user interface to any number of hashtags the followers they wish to see the post follow (for instance if user 1 follows user 1, #inroads and #blue, user 2 may click a sequence of visual buttons on their user interface to create a post to either #inroads or #blue, or both to share the post with user 1, however if they create the post to #red or #green instead, it will not be shared with user 1 said sequence triggering the mobile device to send the request to the application server for processing and sorting the output to the database before possibly sending notice via means such as a push notification to user 1 of the shared post. A follower is a user who has established a Follow relationship with the user who is creating the post. In other exemplary embodiments, users may share posts with other users who are not followers and have not established a follow relationship. Other exemplary embodiments can allow users to share posts with other users based on other relationships such as Like or Support relationships. Other exemplary embodiments can allow users to share posts with other users based on geographical location, also known as geotagging. Similarly, in some exemplary embodiments hashtags, posts, clips, related media and even user profiles may be location based with posts and related media being temporal based. One example of such an exemplary embodiment may be a nationwide dealership that has a regional chain which chooses to manage its sub-profile on a regional level. It can create a geographically-tagged social entity, who is visible to users in that region. It could further create posts related to specific cities in that region, and clips visible to users within a 5-mile radius at a given time. Some such exemplary embodiments may have features including but not limited to automated, temporal, or proximity based posts or related media, such that if a user (for example the dealership) is having a promotion, they can create a post to announce a winner that goes active at a set time well after the post has been created, along with automated posts which are automatically sent to new unique users who enter a particular radius of the store and have their location services turned on, informing them of said promotion via push notification for instance, thereby increasing the likelihood of obtaining business from said users. In some such exemplary embodiments a financial transaction may be required for some or all of the geotagging features. In other exemplary embodiments users may have the ability to block certain types of geotagging notifications and posts altogether, for example a user choosing to block proximity notifications in their user interface would cause their mobile device to send a command to the application server for processing, effectively updating the database to prevent it from sending said user anymore proximity notifications. In certain other exemplary embodiments a financial transaction via the user interface to purchase tokens or an application upgrade may be required to cause the users mobile device to send a command to the application server to block geotagging notifications as well.

In certain exemplary embodiments users may view posts that are shared by other users and interact with the posts through several features visible on their user interface within the post. In this embodiment, some locations within the user interface of the application will show shared posts with users. In these locations, users will view shared posts from other users. In these locations, the posts that are viewable may be determined in the processing unit connected with the application server by means including but not limited to the Follow relationship (whether with a user, a social entity or any combination therein), the Like relationship, or the Support relationship. In exemplary embodiments where the Follow relationship is used to determine viewing access to shared posts, the user will view posts in their user interface from users that the user follows (that is users that the user has a Follow relationship with that is in an affirmative state in the application database). In other exemplary embodiments users may also view posts by matching social entities, in this case hashtags, that are assigned to the post. In such an exemplary embodiment in order to match a hashtag, a hashtag assigned to the post must also be a hashtag that the user has a Follow relationship with that is in an affirmative state. Therefore, the Follow relationships between hashtags and between other users may determine which shared posts users will view at a given location within the application. Other exemplary embodiments may have other relationships that determine viewing access to posts such as Like or Support relationships between other users and between hashtags or other social entities. Other exemplary embodiments may not use relationships to determine viewing access to shared posts.

In some exemplary embodiments, locations within the application user interface that show shared posts and allow users to view and input commands too direct the application server to allow them to interact with posts that have been shared have the following relationships which are in an affirmative relationship state including: A home screen' Timeline Tab; A home screen' Following Tab; A home screen' Popular Tab; and a user's Profile Page.

A home screen timeline tab is a tab on the user interface that in some exemplary embodiments will display posts from other users so long as the viewing user has a follow relationship with users and follow relationship with hashtags. In other exemplary embodiments the posts shown on the timeline will only include those from a limited subset of the hashtags the viewing user is following, a subset which must be selectively narrowed by the viewing user. In other exemplary embodiments this subset may be selected from a menu on the user interface within the timeline which is automatically populated by the server according to the hashtags the viewing user is following, and allows them to select and deselect a plurality of hashtags, which may be a capped or uncapped number selected at the discretion of the facilitator. In yet other exemplary embodiments, the subset may be selected from hashtags the user is following or from hashtags the user isn't following, the difference being that the hashtags the user is following will automatically populate to the top of the selectable menu in some exemplary embodiments, will be the only hashtags visible without conducting a search within the menu in other exemplary embodiments and only public hashtags will be available to choose from in yet other exemplary embodiments. This differs from the selecting a hashtag in the search tab in ways including but not limited to that in some exemplary embodiments selecting a hashtag the user is not following on the timeline will not cause posts to display on the users following tab and the user may select several such hashtags to view at once causing the selected hashtags to float to the top of the search menu. The timeline also may differ from the following tab in that the user will be able to see public posts from public users in addition to those from private users that the viewing user is following, but not private posts from either unless the viewing user is following both the timeline and the hashtags the private post is posted to. Also in some exemplary embodiments the timeline will provide a listing of posts that are fully viewable by the viewing user scrolling down the timeline, whereas the following tab may only show thumbnails of posts which must be further clicked to view the post in full and select or view any interactions including but not limited to clips, wires and like functionality.

A home screen following tab is a tab in the user interface that is populated by the application server in some exemplary embodiments with posts selected from users the viewing user has a Follow relationship with and hashtags the viewing user has a Follow relationship with. In some exemplary embodiments, both of these relationships must be present in order for posts to be visible on the users following tab.

In exemplary embodiments where a home screen Popular Tab is present, it may consist of posts where the viewing user has a Follow relationship with any of the hashtags it is posted under in the database and the post reaches a certain threshold of application server processed statistically monitored criteria including but not limited to Likes, Support, Views, Clips, Saves, Samples, or similar criterion. In some exemplary embodiments this may be composed of posts from users the viewing user has a Follow relationship with whereas in others it may be inclusive of all public posts from all public users to said hashtag the viewing user is following.

In some exemplary embodiments shared posts will be visible in a viewing user's user interface on a posting user's public profile page so long as the viewing user has a Follow relationship with any of the hashtags the post is posted to. In other exemplary embodiments this interaction is only possible in the case of a private user's profile page so long as the viewing user has established a Follow relationship with the posting user as recorded in the application server database. In other exemplary embodiments shared posts will be visible to a viewing user in their user interface on a posting user's profile page so long as the post was made public and to a public hashtag, whether the viewing user is following the hashtag or not. In yet other exemplary embodiments if a user is viewing a profile with no visible posts, the space where posts would usually be shown may be used for advertising or displaying an attractive interactive logo.

Shared Posts will be displayed in the viewing user's home screen under the Timeline and Following Tabs on the user interface. Users can view and interact with shared posts in the home screen under both tabs. In some exemplary embodiments the Timeline and Following tabs work together to display shared posts from all hashtags that a user has a Follow relationship with. In such an embodiment, shared posts in the Timeline and Following Tabs are from users who the user has a Follow relationship with while also from hashtags that the user has a Follow relationship with. At least one hashtag that the viewing user has a Follow relationship with must match the hashtag(s) that the shared post is assigned to, as recorded in the application database in order for the application server to process and send data to populate the viewing user's user interface on their mobile device with any data related to the post.

In certain exemplary embodiments both the Timeline and Following Tabs are intertwined in the database to effectively work together by the application server processing data regarding which tags the user has selected in the user interface to display on their timeline from the tags they are following, in order to send a signal from the server to the user's mobile device for the user interface to display shared posts that are assigned to all of the hashtags that the user has a Follow relationship with. In these exemplary embodiments both the Timeline and Following Tabs of the user interface will only display shared posts from hashtags that the user has a Follow relationship with in the application database. Therefore, both tabs display shared posts that are assigned to a finite group of hashtags. The Timeline Tab displays shared posts assigned to a subset group of hashtags created from the finite group of hashtags. The Following Tab displays shared posts assigned to the remainder of the hashtags within the finite group of hashtags but not within the subset group of hashtags. This means in some exemplary embodiments that a shared post will be displayed in either the Timeline Tab or the Following Tab but not both. Other exemplary embodiments may have a shared post in both the Timeline and Following Tabs.

A tag is an association between a post and a user that is created by the creator of the post selecting an option within the post creation menu of the user interface in certain exemplary embodiments for the aforementioned user to be tagged to the post in the database, which may send the aforementioned user's mobile device a notification that they have been tagged. In certain exemplary embodiments, a user that is tagged to a post gains access to additional features and functions of the shared post. In some such exemplary embodiments, a user that is tagged to a shared post gains access to features and functions of the post that are generally reserved for the creator of the post.

The tag module is a feature of the post and is used by the creator of the post to tag other users to the post. In some exemplary embodiments every post has a tag module in the user interface which includes the functionality of tagging a user or users to the post, by their mobile device sending a request to the application server to process and update the database accordingly. While creating a post, the user can enter the tag module and select users to tag to the post before sharing the post. In certain exemplary embodiments, the creator of the post will only be allowed to tag a user that has a Follow relationship with the creator of the post. In some such exemplary embodiments the creator of the post can tag a user in the post during the process of creating and sharing the post or after the post has been shared by editing the post.

In one exemplary embodiment of the present disclosure, users who have been tagged to a shared post will be listed in the Tagged List within the database which is part of the template of a shared post visible on the user interface. Users viewing the shared post will have access to the Tagged List and can see the list of all users tagged to the post. A tagged user may also have the functionality to un-tag or break their association with a shared post at which point the user would lose all additional features and functionality of the shared post accessible to tagged users. In certain exemplary embodiments the creator of the post would share this functionality to un-tag users they tagged, by editing the post.

In some exemplary embodiments, a user that is tagged to a post in the server will then have their user interface populated with clips so that the user gains access to view all clips that are posted in the post's clip module in the database. The tagged user also gains access to the ability to create Follower and Public clips by selecting from Follower and Public user groups when creating a clip in the user interface and selecting a group of users to give access to such that a list of the selected group of user is sent from the selecting users mobile device to the application server for processing and updates the database accordingly to grant access to that group of users and in certain exemplary embodiments the application server sends notices to the mobile devices of the selected groups of user. In other exemplary embodiments the visibility of each specific clip will depend on whether the user is following the user that posted the clip, is tagged in the posted clip, is mentioned in the posted clip, if the posted clip is public or private or any combination therein.

In some exemplary embodiments users that are tagged to a post will be able to see the post and all features of said post regardless of the post's privacy settings which may have otherwise prevented the tagged user from being able to view it. In some such exemplary embodiments the application server processor will assign all rights and privileges to such tagged users that the original poster would ordinarily be assigned.

In certain exemplary embodiments of the present disclosure, users utilizing the tag module of the user interface will have the ability to merge user groups from the creator of the post and all tagged users. The creator of the post and tagged users will be able to merge all users who have a Follow relationship with the creator of the post or any user tagged to the post. Merging is a function that allows tagged users to select additional users to interact with content by the tagged user selecting the additional users from a merge feature within the post in the user interface, thereby causing the list of selected users to be sent from the tagged users mobile device to the application server via the internet, and processed by the application server populating the application database such that the selected users outside of their normal pool of users thereby increasing the pool of users that will have access to clips, wires, likes, and other features and functionality associated with a post.

In some exemplary embodiments a user will have the ability to repost a shared post that the user is tagged to. When a tagged user utilizes their user interface to repost a shared post, the request to repost will be sent from the tagged user's mobile device to the application server where the request will be processed and update the database permissions for the selected user, thereby allowing the post to be shared with users in the same manner as described for a shared post by the user that created the post. The repost will be shared with all users that have a Follow relationship with the tagged user that is reposting the shared post.

In some exemplary embodiments of the present disclosure, a user that is tagged to a shared post will have the ability to tag other users to the post just as the creator of the post would. In some such exemplary embodiments, a user that is tagged to a shared post will be able to tag other users that have a Follow relationship with the user. For example, a post may be posted by user 1 and only visible to the followers of user 1. If user 1 tags user 2 in this post, user 2 may be granted the ability to tag other users to the post including those not following user 1, so long as they are following user 2.

In some exemplary embodiments the creator of a post will be able to tag a social entity to the post via the tag module. In some such exemplary embodiments, social entities are represented by hashtags; therefore, the creator of the post will be able to tag a hashtag or hashtags to the post by selecting the hashtags from a submenu within the tagging module of the user interface, which then causes the posting users mobile device to send a signal to the application server for processing, thereby populating the database by assigning the post to all of the users that follow the posting user and the hashtag(s) in certain exemplary embodiments, or all users following the hashtag in other exemplary embodiments regardless of whether they follow the poster. As mentioned previously, a user that is tagged to a post gains access to additional features and functionality of the shared post. When a hashtag is tagged to the post, whether the user group that will gain access to the additional features and functionality and what features and functionality may apply may be determined in a variety of ways. In some exemplary embodiments when the creator of a post tags a hashtag to the shared post, users who both have a Follow relationship with the creator of the post and a Follow relationship with the hashtag that is tagged to the post will gain access to the additional features and functionality of the shared post reserved for tagged users. As such users who have a Follow relationship with the creator of the post and a Follow relationship with the hashtag tagged to the post, become the users tagged to the post. In other exemplary embodiments these features may be restricted or functionality limited unless the user is directly tagged to the post without the use of a hashtag. In yet other exemplary embodiments, the creator of the post will have the option to select what functionality and features they wish their followers following the social entity to possess. In yet other exemplary embodiments the creating user may have the ability to tag all followers of a hashtag or social entity, even if those users are not following the creator of the post.

A wire is a text, photo, audio, video, audio-visual, or media file that is created and attached to a shared post. A wire module is an attachment to a post that may selected by a user clicking on the post in their user interface in some exemplary embodiments and clicking on a wire button associated with a post in their user interface in others. In some exemplary embodiments every shared post has a wire module which includes the functionality of creating a wire to attach to the post by the creating user selecting the function within their user interface thereby causing the mobile device to send a signal to the application server for processing, where the application server updates the database and assigns the wire to the selected post and user before sending a notice to the receiving user's mobile device which may be displayed as a push notification on their user interface allowing for the linked viewing of a wire attached to the post. In such exemplary embodiments users who have access to the post will have access to the wire module. The media used to create the wire can be created within the app or uploaded from an external device including but not limited to the memory of a mobile phone or pulled from another social media platform. In some such exemplary embodiments the wire is attached to the post from which it was created and is accessible to a finite number of users. In certain exemplary embodiments these users may be selected from followers of the wire creator, while in others it may be limited to followers of the wire creator that could see the post, in others it may be selected from followers of (a) hashtag(s), while in others it may be limited to anyone who can see the post.

In certain exemplary embodiments the wire module is a feature of the post and is part of the template for displaying a shared post. The wire module can be engaged by a user when viewing the shared post in their user interface and selecting a wire button. In some such exemplary embodiments when a user viewing a shared post enters the post's wire module, the user accesses features and functions associated with viewing and creating wires that have been or will be attached to the post. In these exemplary embodiments creating a wire is a function within the wire module and the wire module is a feature of the post and part of the template for displaying a shared post.

In some exemplary embodiments after a user accesses the wire module from a shared post, the user will be able to create a wire. In some such exemplary embodiments before or after the wire is created and attached to the post, the user must specify which user or users will have access to the wire from within the wire module of the shared post of the user interface. Determining which users will be able to access the wire from the post's wire module can be done in a multitude of ways in different exemplary embodiments. In some exemplary embodiments, wire accessibility will depend on the privacy setting of the post, the privacy setting of the profile of the user who created the post, and the hashtag(s) that the post is assigned to in the application database.

In other exemplary embodiments, posts created from a user with a profile with a public privacy setting will allow all users to access a wire file by selecting the post's wire module in their user interfaces causing their mobile devices to send a request to the application server to view the data accordingly in some such exemplary embodiments, or in other exemplary embodiments the mobile devices will have been preloaded with the associated data when he wires were created, and the selection of the wire will cause it to play without the need for a further request from the requesting user's mobile device to the application server. Thus posts created from a user with a private privacy setting will restrict users from accessing the wire file based on the user's follow or lack of follow relationship with the user who created the post and also by the hashtag(s) the post is assigned to. If the privacy setting of the post is public, all users who have a follow relationship with the user who created the post can access the wire file though the post's wire module. If the post is private, all users who have a Follow relationship with the user who created the post and a Follow relationship with a hashtag the post is assigned to will be able to access a wire file from the post's wire module. This means that in such an exemplary embodiment if the privacy setting of the post is public but the user who created the post has a profile that has a private privacy setting, some users may not have access to the wire in the wire module but only because these same users do not have a follow relationship with the creator of the post. In yet other exemplary embodiments users may post wires to (a) hashtag(s). In such exemplary embodiments, followers of the hashtag(s) the wire is posted to who could already see the post may be able to see and interact with the hashtag whereas other users may not be able to. In some such exemplary embodiments, only followers of the hashtag(s) who also follow the posting user may have such interactions.

In some exemplary embodiments of the present disclosure there exist no privacy restrictions for the creator of a post. In other words, a creator of a post would be allowed to edit the post, see and delete any clips, see and delete any wires, and respond to users as necessary by selecting such functions in the user interface on their mobile device, which then sends a signal to the application server to process such functions and update the database accordingly.

The wire module is a feature of the post and is part of the template for displaying a shared post. In some exemplary embodiments the wire module can be engaged by a user selecting wires in their user interface when viewing the shared post. In such exemplary embodiments once a user has entered the wire module, the user will be able to view all wires that have been attached to the post that the user has access to. In some exemplary embodiments users or the creator of a post will be able to reply directly to a wire by selecting reply within a wire on their user interface, allowing the user to send a reply with the same kind of wire automatically selected in certain exemplary embodiments while other exemplary embodiments may include the ability to reply with any number of options including but not limited to text wire, audio wire, video wire, or emoji wire, in either case the reply being sent from the user's mobile device to the application server for processing and updating the database accordingly before sending a notice to the receiving user's mobile device. In other exemplary embodiments a user or the creator of a post may only reply directly to a wire by selecting reply within a wire and the social networking platform will automatically load a reply in kind to the type of wire received, such as a text wire to reply to a text wire, an audio wire to reply to an audio wire, and a video wire to reply to a video wire.

A clip is a text, photo, audio, video, audio-visual, or media file that is created by a user utilizing the user interface of their mobile device to send the related data to the application server via the internet, where the data is processed and attached to a shared post as a clip. In some exemplary embodiments every shared post has a clip module which includes the functionality of creating a clip to attach to the post and viewing a clip attached to the post. In some such exemplary embodiments users who have access to the post will have access to the clip module. The media used to create the clip can be created within the app or uploaded from an external source included but not limited to the memory of a mobile phone, a computer hard drive or pulled from another social media platform or website.

The clip module is a feature of the post and in some exemplary embodiments is part of the template for displaying a shared post in the user interface. The clip module can be engaged by a user when viewing the shared post in their user interface. In some such exemplary embodiments, when a user viewing a shared post enters the post's clip module of their user interface, the user accesses features and functions associated with viewing and creating clips that have been or will be attached to the post. In such exemplary embodiments creating a clip is a function within the clip module and the clip module is a feature of the post and part of the template for displaying a shared post.

In some exemplary embodiments after a user accesses the clip module from a shared post, the user will be able to create a clip. In some such exemplary embodiments the user must specify which user or users will have access to the clip from within the clip module of the shared post before or after the clip is created and attached to the post. Determining which users will be able to access the posted clip from the post's clip module can be done in a multitude of ways in different exemplary embodiments. In some exemplary embodiments, clip accessibility will depend on the database relationship between the creator of the posted clip and the user accessing the clip module. In other exemplary embodiments clip accessibility will depend on the database relationship between the user accessing the clip module and the social entity the post is attached to. In yet other exemplary embodiments clip accessibility may depend on some combination of both. In yet other exemplary embodiments, clip accessibility may depend on the hashtag(s) the user accessing the clips follows. For instance, a clip can be designated to followers of a user who also follow a designated hashtag. In some such exemplary embodiments, while the post may be posted to a particular hashtag, the clip may be posted to another hashtag such that users have database associations with the hashtag and the poster allowing them to see the post in their user interface and follow the selected hashtag the clip is posted to can see the clip as well and potentially interact with it, whereas other users who don't follow the hashtag the clip is posted to but only the hashtag the post is posted to will only be able to see the post in their user interface but not the clip posted to it.

In some exemplary embodiments, as part of the process of creating a clip, the user will select the users or group of users who will have access to the clip through the post's clip module of their user interface, which sends a signal to the application server to process the selected users or group and update the database access list for the clip accordingly. In some exemplary embodiments users may select between all followers or a subset of the group of followers such as those followers that also follow (a) hashtag(s). In some exemplary embodiments, the user will select from among three groups of users who will have access to the clip through the post's clip module. In such exemplary embodiments the three groups of users are Public, Private, and Followers. Other exemplary embodiments can have one or more groups of users with their own individual unique designations. Further still, other exemplary embodiments can have a direct clip designation in which access to the clip is given directly to a specific user. The different user or users who can have access to a clip from the clip module may be determined by clip designations the user selects in the user interface including but not limited to Direct clips; Private Clips, Follower Clips, and Public Clips

Direct Clips may be created when an individual user selected by the creator of the clip in the user interface, causing the creator's mobile device to send a signal to the application server for processing and updating the database to assign the clip to the creator and the selected user, both of whom will have access to the clip.

Private clips may be created when the creator of a clip designates a clip by selecting a feature in their user interface causing their mobile device to send a signal to the application server for processing before populating the database in a way that grants permission for the clips to be viewable to a private group of users as opposed to anyone who can see the post. Private clips may be accessed and modified by the creator of the post which the clip is posted to and any user that is tagged to the post.

Follower clips are clips created by a creating user selecting a feature in their user interface causing their mobile device to send a signal to the application server for processing before populating the database in a way that grants permission for the clips so that any user that has a Follow relationship with the creator of the clip will have access to the clip. Follower clip can also be created so that any user that has a Follow relationship with the creator of the clip and a follow relationship with (a) hashtag(s) have access to the clip.

Public clips are clips created by a creating user selecting a feature in their user interface causing their mobile device to send a signal to the application server for processing before populating the database in a way that grants permission for the clips such that all users will have access to the clip may access the clip. Public clips can also be created so that all users that have a follow relationship with (a) hashtag(s) may access the clip.

The privacy settings of a post may further determine the visibility of any clips created to that post. For a user who is not the creator of the shared post or tagged in the shared post, the privacy setting of the shared post may allow the application server's processor to determine which group of users will be allowed access to the user's posted clip and populate the database accordingly. The privacy setting of the post may not determine which group of users will be allowed access to the user's posted clip when the user is the creator of the shared post or any user tagged in the shared post.

In some exemplary embodiments of the present disclosure, the privacy setting of a post is either Public or Private. A post with a Public privacy setting will allow users who have access to the post and access to the post's clip module to create and post a clip in the clip module to any group of users Private, Followers, or Public in this embodiment. A post with a Private privacy setting will allow users who have access to the post and access to the post's clip module to create and post a clip in the clip module to only the group of users designated Private in the application database. In some such exemplary embodiments, the Private user designation refers to the user who created the post and any user tagged in the post. In this way, the Private privacy setting on a shared post restricts some users from posting a Public or Follower clip in the clip module of a shared post created by another user.

In some exemplary embodiments the creator of a posted clip will always have access to the posted clip in the post's clip module. In such exemplary embodiments the application database may be populated as associating the posted clip with the creator of the clip for viewing and/or editing such that the creating poster may still view the posted clip in their user interface and in certain exemplary embodiments further edit the clip in means including but not limited to creating text on the clip or editing the users the clip is visible to.

In some such exemplary embodiments, the creator of the post will also have access to every clip that is posted in the post's clip module. Any user that is tagged in the post will also have access to every clip that is posted in the post's clip module. In such exemplary embodiments the application database may be populated as associating the posted clip with the creator of or tagged users to the post such that the creator or tagged users may still view the clip in their user interface.

A Reply Clip is a clip created in response to a clip. In some exemplary embodiments reply clip accessibility will depend on the relationship between the creator of the posted reply clip and the user accessing the clip module. As part of the process of creating a reply clip, the user may select, through their user interface, the users or group of users who will have access to the reply clip through the post's clip module in the same way that was described for creating a clip. In some exemplary embodiments, the creator of the reply clip can only select a user or group of users that also have access to the clip that is generating the reply clip. For example, in some such exemplary embodiments, a Public clip will be able to generate a Public, Followers, Private, or Direct reply clip. In such exemplary embodiments, a Private clip will be able to generate a Private or Direct reply clip.

In some exemplary embodiments, the clip module is a feature of the post and is part of the template for displaying a shared post. In such exemplary embodiments the clip module can be engaged by a user when viewing the shared post in the user interface. In some such exemplary embodiments once a user has entered the clip module, the user will be able to view all clips that have been posted to the post that the user has access to.

When a user enters the clip module from a post, the user may view all posted clips that the user has access to. In some exemplary embodiments, all of the clips can be separated into two different groups, Following and Not Following. The Following Tab will contain all posted clips from users that the user has a Follow relationship with as sorted by the application server's processor in the database. The Not Following Tab will contain all posted clips from users that the user does not have a Follow relationship with as sorted by the application server's processor in the database.

In some exemplary embodiments, the creator of a reply clip can select, through their user interface, a user or group of users that also have access to the clip that is generating the reply clip. In some such exemplary embodiments, when this occurs, the creator's mobile device will send a signal to the application server where the application processor will update the database accordingly so that the user or users that have access to both clips can have both the initial clip and the reply clip played one after the other when viewing a reply clip in their user interface on their mobile devices.

In some exemplary embodiments a user may have the option in their user interface to select to play all clips associated with a post in the application server database. In some such exemplary embodiments the user may see an icon indicating the next clip that is set to play and will have an option to skip it or any subsequent clips while still viewing the clip that is playing. In other exemplary embodiments other methods of skipping subsequent clips may exist including but not limited to skipping clips of a certain type such that a user skips all public clips and skips ahead to the next private clip or vice versa, skipping a preset quantity of clips (such as skipping ahead 2 clips) or skipping ahead a certain period of time between clips (such as 15 second ahead or back, whether said clip is over 15 seconds or not such that a user may skip over an entire clip which is 10 seconds and start 5 seconds into the next clip).

Some exemplary embodiments of the present disclosure may include the ability to select in the user interface and send from their mobile devices through the application server to other users' mobile devices, functional media including but not limited to emoji streams, emoji hieroglyphics or a combination of the two. An emoji stream is a video, audio-video, or media file that plays emoji images in a user created sequence. In this embodiment, the emoji stream is created within the app and can be used in different locations. In this embodiment, the emoji stream is a feature of the clip and wire modules. In other exemplary embodiments, an emoji stream can be used by itself or in other modules within the app. Emoji hieroglyphics are an organized chart of emoji's which may be selected to fill in blanks. In some such exemplary embodiments emoji hieroglyphics may be used to fill out blanks in a giant number sign that can be sent to another user to tell a story. This may include a number sign that is filled with 9 emoticons which are used to convey a message between users, when the emoticons are read in a particular pattern such as left to right then up to down. In other exemplary embodiments an emoji hieroglyphic stream may be sent to another user with the hieroglyphics set to display for a predefined time by the creator suitable for the recipients. In other exemplary embodiments emoji's may have language translations where one word is associated with one emoji image and a translation is available for an emoji stream, emoji hieroglyphic or emoji hieroglyphic stream. In some such exemplary embodiments the social networking platform may display a language translation for the emoji media including but not limited to emoji streams or emoji hieroglyphics.

An emoji stream is a user created sequence and therefore the user must input emoji images in a designated order in their user interface so that the mobile device sends a signal to the application server for processing. Within the emoji stream feature, there are pre-established rules that take the user's input, create an emoji stream, and output the emoji stream in a media file.

In some exemplary embodiments, a user may input emoji images one by one in order in wires or clips on their user interface. A user may also set Emoji Streams Rules for timing and playback of emoji's such as the amount of time each emoji will display for in a stream. Other options may exist such as how to position Emoji's on screen to arrange the playback in different locations.

In certain exemplary embodiments of the present disclosure users may save posts as bookmarks by selecting a feature associated with the post in their user interface which causes their mobile device to send a signal for processing to the application server to populate the database accordingly. In some such exemplary embodiments bookmarks may be accessible from the user's profile. In others users may have a module for saved posts.

In some exemplary embodiments of the present disclosure a user's posts will be visible under separate sub-menu within another user's interface so the other user can drill down the social entity they are posted under, in this case hashtags. One example of this may include a user's profile having links to each of the hashtags they have posted to, and once a viewing user selects such a link, posts to that hashtag by the user whose profile is being viewed, will be displayed. In other exemplary embodiments the links to hashtags may be limited to hashtags the viewing user is following. In other exemplary embodiments other rules may apply such as public hashtags being viewable as links but only private hashtags the viewing user is following also being visible; public hashtags being visible only, or any combination therein.

In some exemplary embodiments of the present disclosure the option to create text wires may exist in a separate menu where data may be entered into a text box sending a signal for processing to the application server to populate the database accordingly. The text box may allow a multitude of features to be selected, including but not limited to the selection of font, color, or size. Additionally, in some exemplary embodiments the background color of a text box may be selected and watermarks may be added or edited in some such exemplary embodiments. When a text wire is sent in this manner, the selected background color and watermark may be viewable to the recipient. In some exemplary embodiments the only selectable watermark may be on that includes the name of the social media platform. In other exemplary embodiments users may be allowed to create a watermark to act as a signature. In yet other exemplary embodiments additional watermarks may be created via a token exchange system for public or personal use. For example, a store, Stacy's, can reserve a #Stacy's watermark for use by their followers for a number of tokens or other bargained for legal detriment for a set period of time.

In some exemplary embodiments audio wires may be created by inputting a command to the user interface to send a signal to the application server for processing, setting the audio to be played with the post, clip or replied to wire in the database such that they playback to the recipient with the image or video of the original post, clip or replied to wire displayed alongside the playback of the audio from the wire. In other exemplary embodiments a created audio wire will playback without an image being displayed. In yet other exemplary embodiments the creator of an audio wire may choose to select a post or video to attach to said audio wire.

In some exemplary embodiments of the present disclosure, users may mention hashtags or other users. This may be accomplished in some exemplary embodiments with the use of the @ sign being typed in the user interface preceding a user name or hashtag. This causes a signal to be sent to the application server where the processor creates a mention in the database which may sent a signal to the mobile devices of the mentioned users in some exemplary embodiments. In some such exemplary embodiments, users can use the @ function to mention a hashtag to either all followers or users who follow the hashtag.

In some exemplary embodiments of the present disclosure banner adds may be located in locations correlating the users interest with the product or service advertised. For instance, in some such exemplary embodiments banner adds may be interspersed with posts on a timeline if key words in the advertisement relate to one of the hashtags selected in the user interface of the user's timeline, such that the application server processor conducts active searches for keywords in the advertisement description and corresponding text in the hashtags associated with the user before populating the user's advertising banner with the corresponding advertisement or series of randomly generated and possibly rotating advertisements. In other exemplary embodiments the same functionality may cause advertisements to appear in other menus based on whatever social entities the user is following.

In some exemplary embodiments of the present disclosure a user may be presented in the user interface with a feature to sample a post causing the user's mobile device to send a signal to the application server for processing before populating the database in a way that pulls the post into a sample post portion of the database associated with the user in order to reuse the content of the post in a new post. In some such exemplary embodiments these sampled posts will be linked to the original post such that the original post will display the number of times the post has been sampled and the number of samples will serve as a link to the sampled posts. In other exemplary embodiments the creator of a post may have the option in their user interface to choose whether to allow their posts to be saved or sampled or may control the saving and sampling of posts by either creating a public post which others may save or sample or by creating a private post which does not allow saving or sampling. In yet other exemplary embodiments a sampled post may contain a link to the original post or an automated caption giving credit to the original poster and noting it is a resampled post (for instance user X selects to sample a post of user Y in their user interface. The user interface sends a single to the server indicating the sampling and the processor automatically populates the database for the post's caption with the text “sampled from user Y”.).

In some exemplary embodiments of the present disclosure users may create a comment marker by utilizing a comment marker feature of their user interface and selecting a part of an image or a video posted in order to leave a comment on, their mobile device by a sending a signal to the application server for processing before populating the database and assigning the comment marker to a select region and possibly time of the post such that if the marker is selected by a viewing user on their mobile device's user interface, the entire caption would be visible. In some such exemplary embodiments this selected portion of an image may be indicated by a designation including but not limited to a particular color, symbol or highlight to viewing user such that when the color or highlighted portion of the picture is selected, the comment will be visible. In some such exemplary embodiments users may choose which designation to mark their comment marker with. In other exemplary embodiments users may post replies to a comment marker such that users who click on the comment marker to see the initial comment may see the reply comments posted below the initial comment or by pressing a button to skip ahead to the next reply. In some exemplary embodiments comment markers may flash on and off over a period of time so the user can see the post without interruption. In exemplary embodiments where comment markers are utilized on video the creating user may have the ability to set both the time, location and duration of the comment marker. In yet other exemplary embodiments the comment marker location can be set to change over time and/or update with a series of additional comments from users over time utilizing the same marker. In some exemplary embodiments the comment markers may be a feature which cannot be disabled. In other exemplary embodiments users may have the ability to set their preferences to display comment markers or not. In some exemplary embodiments comment markers may be visible only to followers of the poster or users who can view the post who are also following a particular hashtag the comment marker is posted to. In other exemplary embodiments all users who can view the post may be able to see the comment marker. In yet other exemplary embodiments users may be able to choose to allow comment markers on their posts or not, thus choosing to limit or enable those users who can see their post. In some exemplary embodiments a viewing user may click the comment marker in their user interface to open a text box displaying the associated comment. In other exemplary embodiments the user may be able to set comment markers to automatically play in some sequence including but not limited to order of creation, order of display time, comment markers from ‘followers’ only, or comment markers from ‘following’ only.

Attractive symbols may be used to represent the functionality of the social networking platform in some exemplary embodiments comprising a number sign within a number sign logo (which may also be referred to as a hashtag within a hashtag) which may be static or dynamic moving such that as the animated image zooms in on one number sign another is revealed within any one of its 9 squares, in other exemplary embodiments the number sign may further comprise images or colors in any of its 9 squares further illustrating the functionality of the network in uniting users of different fields of interest via hashtags or displaying the general color scheme of the social media platform. In yet other exemplary embodiments the number sign may spin as the animation zooms to another spinning number sign within any one of its 9 squares. In some such exemplary embodiments the animation may zoom to a different square from one number sign to the next, said square always containing a number sign within it as all other squares contain other images. In other such exemplary embodiments the hashtag within a hashtag may be used as a less intrusive method of notifying a user that they are receiving correspondence from the social media platform while they are using another application (for instance a user in a virtual reality social application may see a hashtag within a hashtag in a predetermined viewing area that when a certain portion of the hashtag is selected causes the notification to either disappear or pull up a virtual cellphone with the social networking platform replicated therein functionally bringing the user to the notified activity and allowing them to interact without ever forcing them to leave the immersive environment of the virtual reality social application). This could work by the application server sending a signal to a reserved space on an accommodating virtual reality application when the database is populated with an indication that the user has received an action that would ordinarily result in a push notification, and the user is using the accommodating virtual reality (VR) application, the processor sending the attractive hashtag within a hashtag logo in a way that it can be displayed in the VR application, and utilizing said dedicated space to display the attractive symbol in such a way that the logo can be selected resulting in it zooming in to a VR phone with the application content user interface duplicated within the VR application.

In some exemplary embodiments of the disclosure, the application push notifications may have their own unique accompanying sound. For instance when a user sends a wire via their user interface to another user, by the mobile device sending a related signal to the application server for processing, when the application server populates the database accordingly such that the receiving users mobile device can notify the receiving user through their user interface, if the application server processor detects that the user is away from their phone such that it is idle, or is using another application, it can send them an audio alert to accompany any push notification, depending on the user settings. In some such exemplary embodiments the audio alert may be set to a default sound, while in others the audio alert may be different for a variety of different features, including but not limited to an audio alert that the user's post has been liked, an audio alert to notify a user that they have been tagged in a post, and an audio alert to notify a user that they have received a wire all being different. In some such exemplary embodiments each audio alert may be populated by a distinctive sound from within the application database to be played back on their mobile device such that the application notices always have the same distinctive prelude such as a drumroll. In other exemplary embodiments the users may set and select the alert sounds as they choose, while in others they may only select the final note of the prelude from their user interface. For instance, if the prelude is a drumroll a user may set the final note to a crash cymbal, gong hit, bass drum strike, marimba note, piano key, or other percussion instrument sound for wires, clips and basic activity panel notifications so as to differentiate one from another audio, while the application still has a distinctive sound to separate itself from the chirps and woodwinds that may represent other social networking sounds where only a single sound is used to represent all alerts. In other exemplary embodiments different sounds may be set for different users, such that user 1 may select users 2 and 3 to be special as compared to users 4-900, such that when set in user 1's user interface, a signal is sent from the mobile device of user 1 to the application server for processing, where the processor updates user 2 and 3 to have a special relationship with user 1 such that the database is populated with a different sound for activities related to that relationship for user 1, so that a different sound is requested to play from the user 1 mobile device by the application server when the application server receives an update from user 2 or 3 in relation to activity that user 1 is to be notified of.

It is understood that the various disclosed exemplary embodiments are shown and described above to illustrate different possible features of the disclosure and the varying ways in which these features may be combined. Apart from combining the features of the above exemplary embodiments in varying ways, other modifications are also considered to be within the scope of the disclosure. The disclosure is not intended to be limited to the exemplary embodiments described above, but rather is intended to be limited only by the claims set out below. Thus, the disclosure encompasses all alternate exemplary embodiments that fall literally or equivalently within the scope of these claims.

Some of the exemplary embodiments of the present disclosure are illustrated in the attached drawings:

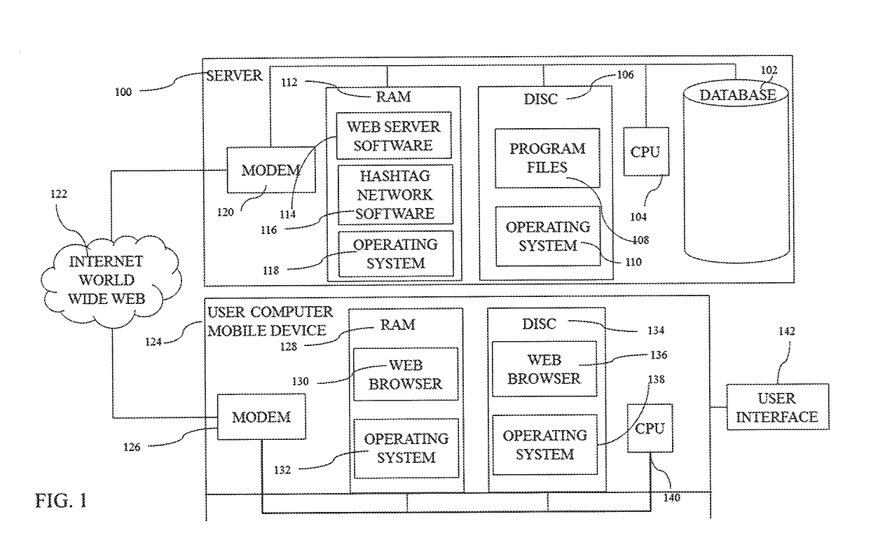

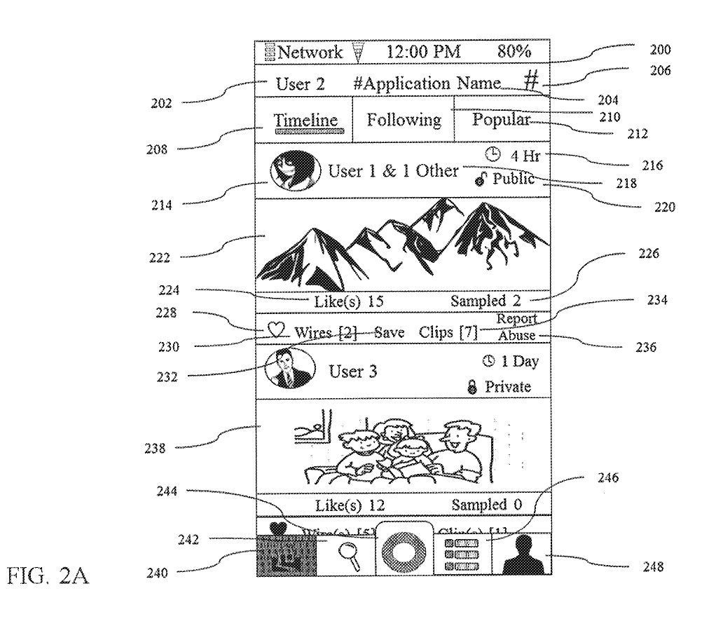

FIG. 1 is an exemplary embodiment following a standard Internet architecture in which user computer/mobile device 124 and a server 100 are connected via the internet 122 and modems 126, 120 or other communications channels. A user accesses the server 100 via their computer/mobile device 124 operating a web browser 130 or other software application residing in RAM memory 128 that allows it to display information downloaded from a server 100. The server system 100 runs server software 114, including the social entity software (In this case Hashtag Network Software) 116 of the present disclosure, which interacts with the user computer/mobile device 124 and a user information database 102. The database 102 contains contact information entered by registered users. The Hashtag Network Software 116 in some situations will notify any number of users of updates made to the database 102 by another user to whom the notified users are related. Both the server 100 and the user computer/mobile device 124 include respective storage devices, such as hard disks 106 and 134 and operate under the control of operating systems 118, 132 executed in RAM 112, 128 by the CPUs 104, 140. The server storage device 106 stores program files 108 and the operating system 110. Similarly, the user storage devices 134 store the web browser software 136 and the operating systems 138. Typically, the user would utilize the social network platform/user interface 142 on their mobile device 124.

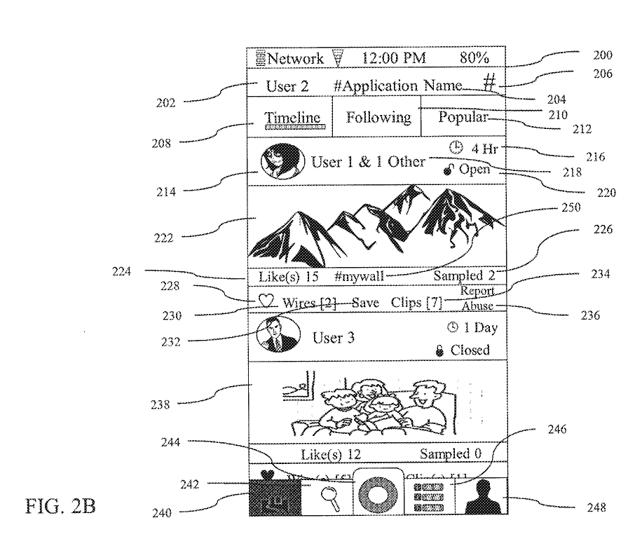

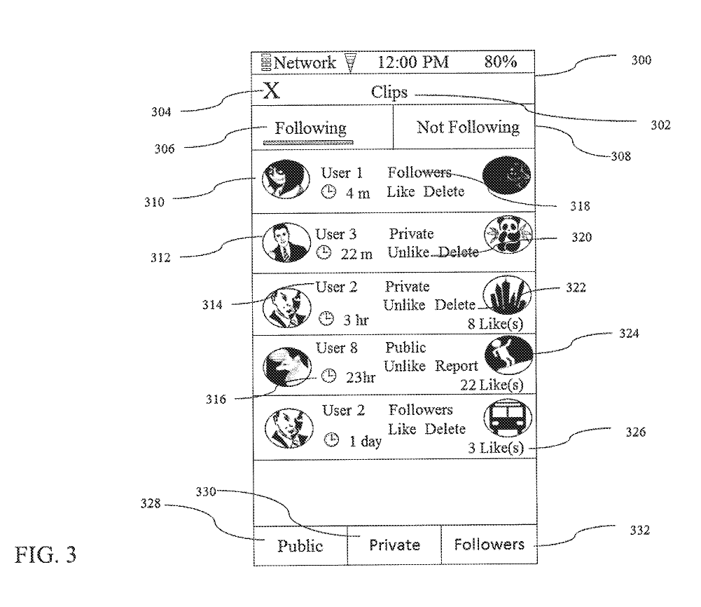

FIG. 2A is an exemplary embodiment displaying a graphical user interface (GUI) 200 (as described in 142 of FIG. 1) for the social networking platform's home-screen. In this exemplary embodiment the user can see their name (user 2 in this case) 202, alongside the name of the application (#Application Name) 204 along with a button (#) 206 to toggle the selection tool for social entities visible on the timeline. The GUI further comprises a Timeline tab 208 (which is underlined because it is presently selected), a Following tab 210, and a Popular tab 212. Posts from users 222, 238 may be displayed in this tab 208, under an icon representing the posting user 214 (which also serves as a link to said user's profile), alongside their screenname and the number of tagged users 218, the time since the post was made 216, the posts privacy settings 220, the number of times someone liked the posts 224, the number of times the post was sampled 226, an option for the user to like the post by depressing a representative button 228, the number of wires received concerning a post 230 (which also serves as a link to said wires), the option to save a post 232 to a user's profile, the number of clips posted to the post as viewable by the user 234 (which also serves as a link to said clips), and the option to report abusive posts 236. At the bottom of the GUI is a series of buttons allowing a user to view the home-screen 240 (which is highlighted because it's currently being viewed), the search tab 242, create a post 244, view activity 246, or view their profile 248. In some exemplary embodiments additional features may be included such as an icon for direct message or wire viewing and notifications in the top left corner which may have an indicator including but not limited to as a color, a flashing action or a number to notify the user of new wires or messages.

FIG. 2B illustrates an exemplary embodiment similar to FIG. 2A, but unlike FIG. 2A, clips in FIG. 2B may be attached to open and closed posts instead of public and private posts. According to an exemplary embodiment, open posts by public users are visible to everyone. For instance, if a second user does not follow the poster, the second user may view the post when a predetermined condition is met. For instance, the second user may view the post when the post reaches the popular tab, if the second user selects the user's profile, or if the second user searches for and selects the hashtag associated with the post. According to another exemplary embodiment, open posts by private users may be visible to their followers, closed posts by public users may visible to their followers who follow any of the hashtag posted to or anyone who receives a wire from the post, and closed posts by private users may be visible to their followers who also follow any of the hashtags posted to or followers who receive a wire from the post. These features of the open and closed posts are merely exemplary, and other variations of the described features may be associated with the open and closed posts.

FIG. 3 is an exemplary embodiment displaying a graphical user interface (GUI) 300 (as described in 142 of FIG. 1) for the social networking platform's clips screen. This GUI 300 is reached when a user has clicked a link to clips within a particular post, such as 234 in FIG. 2A and FIG. 2B. In this GUI it is visible to the user that they are viewing the Clips menu 302. The user will have the option to return to the previous screen by clicking the back button (X) 304, they may also select to view clips posted by those they are following by clicking the Following tab 306 (which is underlined because it is currently being viewed) or the Not Following tab 308. Subsequent rows below the tab may represent each clip 310, with an icon 312 used to represent each posting user, the user's handle 314, the time since the clip was created 316, the privacy settings of the clip 318 the user viewing the GUI's like relationship with the clip 320, options to report or delete the clip 322 (in some exemplary embodiments a user may delete private or follower clips but report public clips), an image representing the clip 324, and the number of likes for a clip 326 (which in certain exemplary embodiments may be visible for public clips and clips created by the user but not private and follower clips created by others). At the bottom of the GUI is a row of buttons enabling a user to create Public Clips 328, Private Clips 330, and Follower Clips 332.

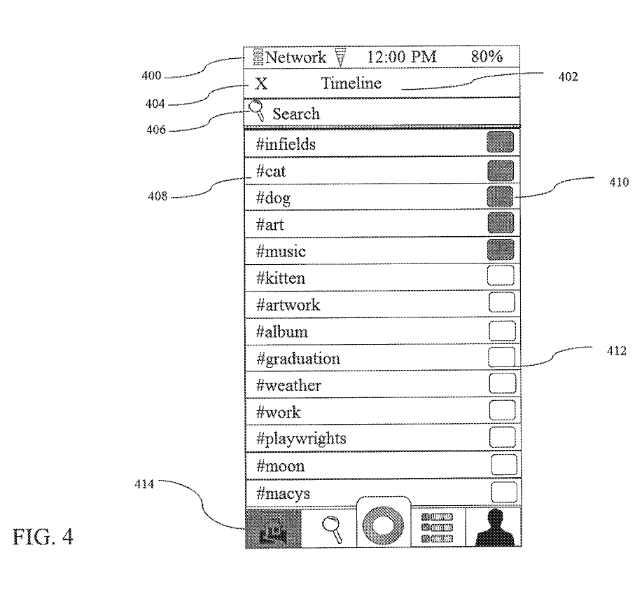

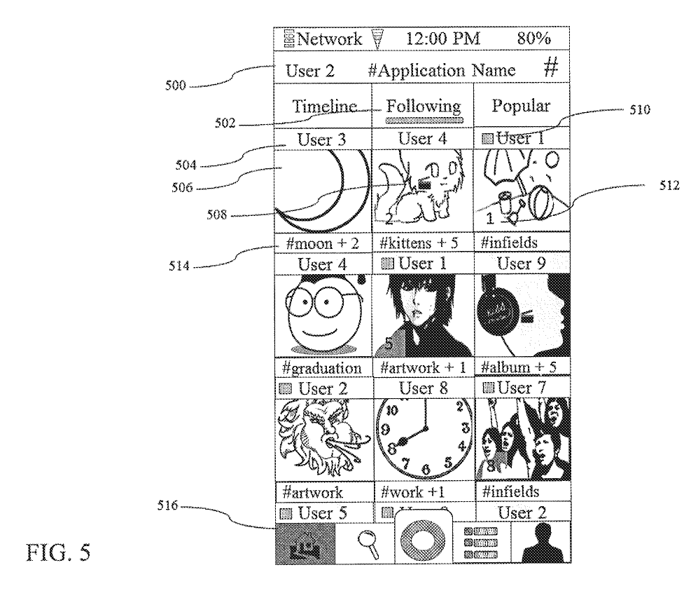

FIG. 4 is an exemplary embodiment displaying a graphical user interface (GUI) 300 (as described in 142 of FIG. 1) for the social networking platform's Timeline selection panel. This GUI 400 is reached when a user has clicked a link to the timeline selection tool such as the number sign 206 in FIG. 2A and FIG. 2B. The timeline selection screen further comprises an indication that they are in the Timeline selection screen 402, a back button 404, an option to search for a particular social entity that may update to narrow similar social entity/hashtag 406, any number of social entities 408 organized with the selected social entities populating the top and the unselected the bottom, with an indication which social entities have been selected 410 and which social entities haven't been selected 412. In some exemplary embodiments of the present disclosure the number of social entities that may be selected is limited to 9. The selection or deselection of these social entities may be performed by clicking he respective squares 410, 412. A highlighted icon may also display to the user that they are viewing a part of the home-screen 414.

FIG. 5 is an exemplary embodiment displaying a graphical user interface (GUI) 500 (as described in 142 of FIG. 1) for the social networking platform's Following Tab 502. In the Following tab posts made by users the user is following to social entities the user is following may be organized with the posting user 504 listed above each post, which may be represented by a thumbnail 506. In cases where a post is a video, an icon may exist on the post thumbnail to denote it as such 508. Wires to the post may be indicated by a highlighted square 510, which may flash in some iterations to distinguish a new wire from an old wire, or be an empty square in other iterations to display that all associated wires have been viewed. An indication that the post has clips associated with it may be denoted on the post 512 and in some iterations the number of clips may be denoted. In some exemplary embodiments clips by users the user is following and wires directed to the user may be distinguished from clips posted by users the user is not following or wires that are not directed to the user respectively by means including but not limited to having the former on the left and the latter on the right of each thumbnail, vice versa, a different color being used for each or a different shape being displayed for each. Further, the number of social entities the post is made to may be listed below the post, with the quantity of social entities in addition to the first that the user is following shown as well 514. Finally, an indication that the user is viewing a part of the home-screen 516 may be shown.

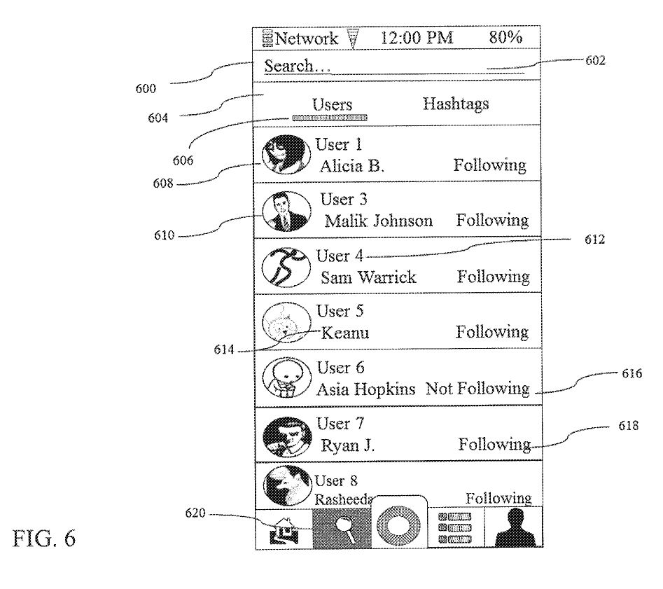

FIG. 6 is an exemplary embodiment displaying a graphical user interface (GUI) 600 (as described in 142 of FIG. 1) for the social networking platform's Users search tab 606. The user can conduct a search for other users by entering a search into the search bar 602. A user may also select which field of data to search 604, in this exemplary embodiment limited to Users and Hashtags. Each row beneath these tabs may display the Users and related information 608, with a user icon 610, screenname 612, associated name 614, whether the user is not following 616 or following them 618 and an indication that the user is in the search screen as indicated by the search icon being highlighted 620. In some exemplary embodiments a user may click the thumbnails of other users to view their profile.

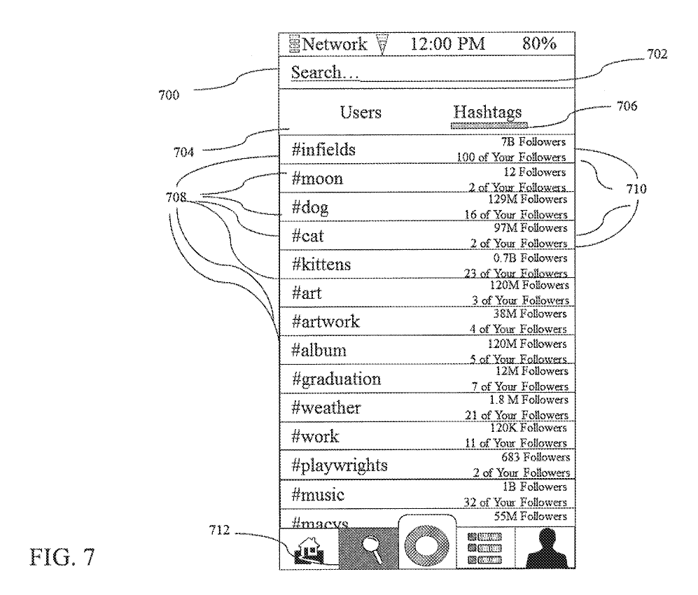

FIG. 7 is an exemplary embodiment displaying a graphical user interface (GUI) 700 (as described in 142 of FIG. 1) for the social networking platform's social entity search tab 706. The user can conduct a search for social entities by entering a search into the search bar 702. A user may also select which field of data to search 704, in this exemplary embodiment limited to Users and Hashtags. Each row beneath these tabs may display the social entities and related information 708, with the number of followers following the hashtag and number of hashtag followers following the user displayed 710 and an indication that the user is in the search screen as indicated by the search icon being highlighted 712.

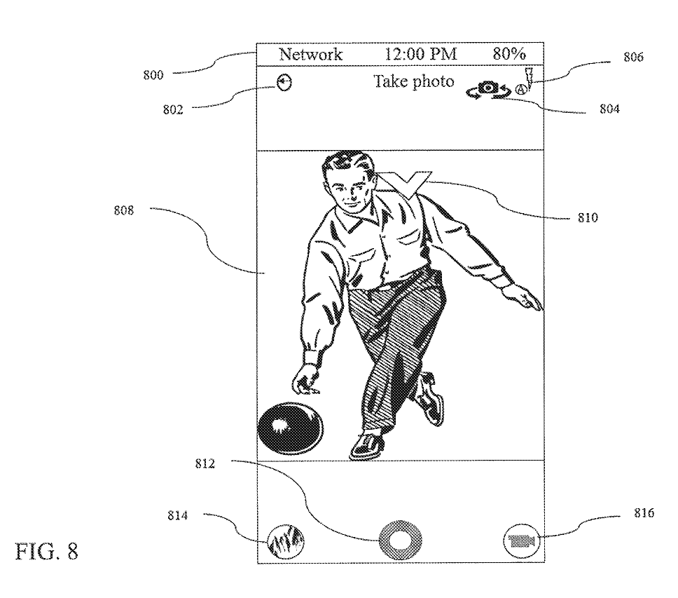

FIG. 8 is an exemplary embodiment displaying a graphical user interface (GUI) 800 (as described in 142 of FIG. 1) for the social networking platform's create a post panel. This GUI may further comprise a back button 802, an option to reverse the camera 804, an option to set their camera's flash to on, off or automatic 806, a screen showing either an uploaded image/video or an image/video from the camera 808, a menu to select pulled posts 810, a button to take an image 812, a button to upload an image or a video 814 or an option to choose to record a video 816. In some exemplary embodiments users may also have options including but not limited to creating text, captions and effects on posts. In other exemplary embodiments selecting the menu to pull posts 810 may include additional features including but not limited to being able to take a screenshot or video directly from the user's phone or the internet from within the social networking platform rather than only being able to upload such screenshots from the mobile devices memory, viewing saved posts for reference or turning on and off features such as the ability to sample or create comment markers for that particular post. In yet other exemplary embodiments a tab may be included to download the photo or video to one's phone while creating it.

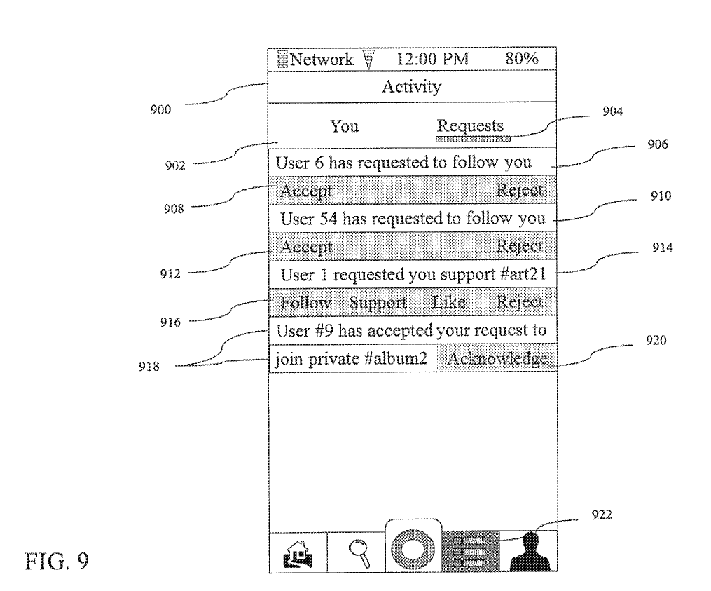

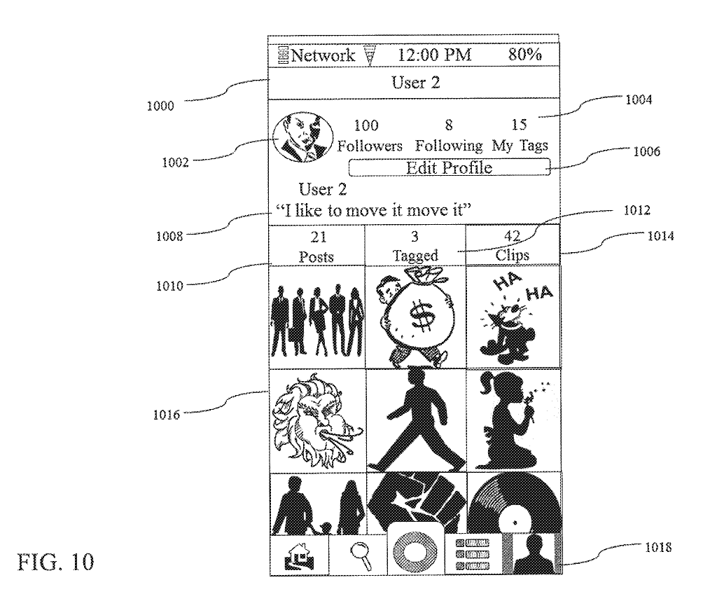

FIG. 9 is an exemplary embodiment displaying a graphical user interface (GUI) 900 (as described in 142 of FIG. 1) for the social networking platform's activity panel. This exemplary embodiment may further comprise tabs for viewing activity related to the user (You) or others (Requests) 902, with the selected tab being highlighted or underlined 904. In this menu users may see activity including but not limited to requests to follow, 906, 910 to support social entities or campaigns 914, or to join private social entities 918. Users may choose to Accept or Reject such requests 908, 912, change their relationship with social entities 916 or otherwise acknowledge requests 920. Users may see an indication that the user is in the activity panel as indicated by the search icon being highlighted 922. In some exemplary embodiments the activity panel symbol on the application's bottom selection toggle bar may be highlighted to indicate new activity in a variety of ways. New activity can include but is not limited to the user receiving a wire, a post of the user being liked, the user receiving a new follower, the users request to follow a private hashtag or user being accepted or one of the user's created posts reaching the popular tab. In other exemplary embodiments notices of requests to the user may be divided from other activity related notices such that only one corner or side of the activity symbol highlights to indicate one type of activity vs the other. In other exemplary embodiments if the activity panel is not selected such that the original highlight remains and another activity occurs a counter could be displayed to indicate that new activity is accruing. In yet other exemplary embodiments the color of the highlighted activity panel toggle icon may change to indicate additional activity occurring. In yet other exemplary embodiments wires may be found in a separate menu from the activity panel, including but not limited to the top left corner of the home screen, or the users profile page, both of which may have icon's that highlight similarly when wires are received. According to another exemplary embodiment in FIG. 9, the “General Post” option results in a post to a default hashtag (i.e., #infields, which the users may not Unfollow).

FIG. 10 is an exemplary embodiment displaying a graphical user interface (GUI) 1000 (as described in 142 of FIG. 1) for the social networking platform's user profile panel. This panel may display the User's profile picture 1002, which may allow the user to click and change the picture, user statistics 1004 related to their quantities of Followers, Following and Personal tags, options to edit their profile 1006, a user created tagline 1008, which may also include emoticons, tabs for user Posts 1010, for posts the user is tagged in 1012, and for user created clips 1014, where posts or clips may be represented by thumbnails 1016. Users may see an indication that the user is in the user profile panel as indicated by the profile icon being highlighted 1018.

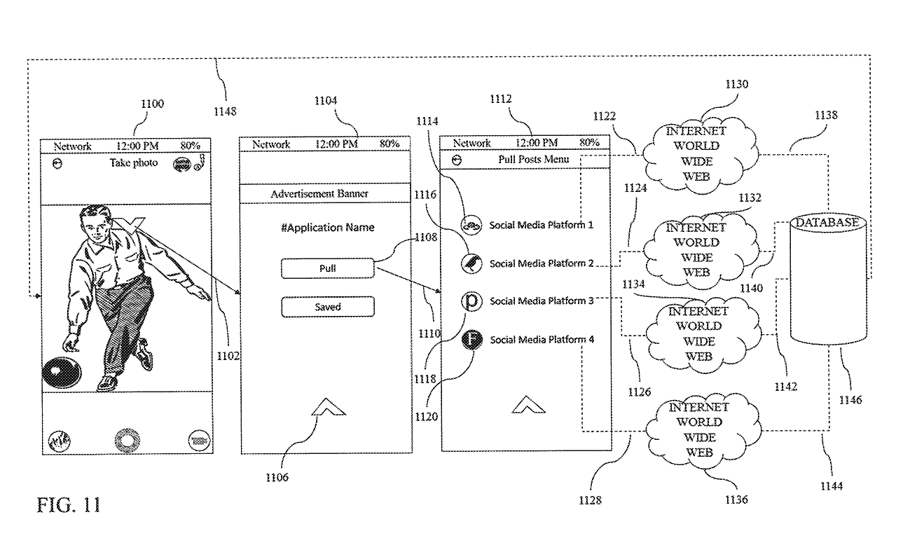

FIG. 11 is a flowchart showing the logic of pulling posts. The user may choose to pull posts in the create a post menu 1100, by clicking the Pull posts arrow in their user interface, users may activate 1102 the insert posts menu 1104. Users may go back to the create a post menu by clicking the reverse arrow 1106, choose to click advertisements, insert pulled posts (1108) or insert saved posts in menu 1104. If a user chooses to pull posts, the GUI will display 1110 the pull posts menu 1112. The user may select between a number of other social media platforms 1114, 1116, 1118, and 1120. Depending which social media platform is selected the application may follow a path 1122, 1124, 1126, and 1128 through the internet 1130, 1132, 1134 and 1136 to pull posts from said social media platforms related to the user or a particular social entity 1138, 1140, 1142 and 1144 and use it to populate the database 1146 which follows a path to populating the user interface with said post 1148.

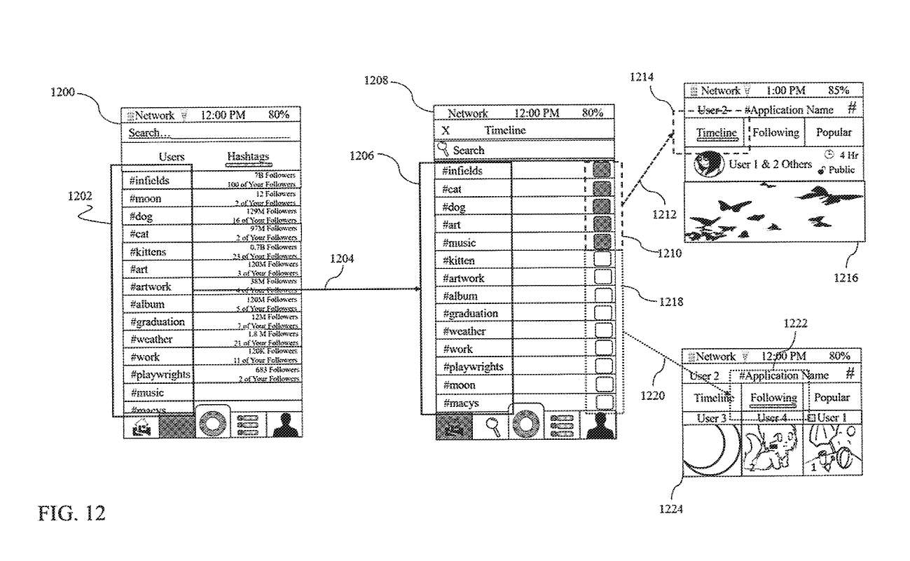

FIG. 12 is a flowchart showing the logic of populating the Timeline and the Following tab. In the search panel 1200, a user may select which social entities to follow 1202, these social entities will then populate 1204 the database which will adjust the timeline search panel 1208 accordingly. Of the social entities which populate the timeline search panel 1206, a user may select those 1210 which will populate 1211 the Timeline tab 1214, the posts to such 1216 appearing therein. Those which remain unselected 1218, will instead populate 1220 the Following tab 1222, the posts to such may appear therein in thumbnail form 1224.

According to an exemplary embodiment, a poster or a user can create and edit features. For instance, the poster or the user may change background color, theme, image, privacy settings of comments related to the post, size of the comments, and the like.

According to an exemplary embodiment, an one-touch (or 1-touch) background may allow a user to change their background theme, a theme being a color, image, and/or video display on a screen of the user device. For example, a user may switch the color from black to white, red, green or any other color, with the one-touch selection (or a push) of a button. According to an exemplary embodiment, the one-touch selection of the button may change the background for several screens in the GUI of the user device, including but not limited to the users timeline, following screen, profile, etc. In another exemplary embodiment, the user may select a custom background for their profile that would be visible when other users view their profile. In some such exemplary embodiments, the background may be a video including but not limited to burning fire in the background, falling snow, or flashing stars.

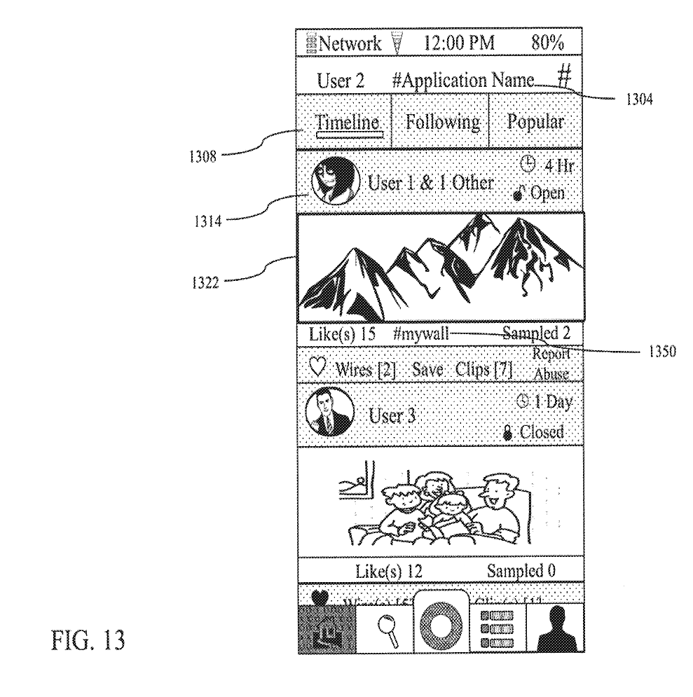

FIG. 13 illustrates an exemplary embodiment of displaying the 1-touch theme change ability of the preset disclosures. For instance, the user may click the “#application name” 1304 (204 in FIG. 2A and FIG. 2B), which changes a color of the background 1308 (208 in FIG. 2A and FIG. 2B). In some exemplary embodiments, the selection of the 1-touch button may invert the background color and certain other colors such as the highlight beneath “Timeline”, while leaving user icons 1314, pictures 1322 and other items the same.

According to another exemplary embodiment, the poster or the user may provide an option, which allows the poster or other users to leave comments on the post. For example, the post may be viewed as a virtual wall, in which, the poster or the other users can leave comments on the post. According to an exemplary embodiment, the poster or the other users may sign the virtual wall, at any location, with customized text font, color, and/or comment background. According to an embodiment, a button to represent a wall post is provided, and when the button is selected or clicked, the user may be able to view the post in full. According to an embodiment, the button may be an image including but not limited to an emoji or uploaded picture.

Moreover, according to an exemplary embodiment, the user viewing the post may see temporal arrows or other selectable buttons that allow the user to click and be instantly transported to a particular comment. According to an exemplary embodiment, the user may click a button such as “see comments” to view the arrows or buttons. In another exemplary embodiment, a button may make the comments appear in list form on the side. According to an exemplary embodiment additional buttons may be provided to see a list of buttons including but not limited to new, private, following and public comments, or lists of user names with lists of comments beneath. According to an exemplary embodiment, the user may zoom out to see each comment, or select a comment in list form, which allows the user to instantly zoom to the comment and view the comment in the original font, size and color etc., of the comment.

According to an exemplary embodiment, utility Hashtags/Demarcations are provided, which when selected or created may result in a desired function. For instance #mywall 1350 shown in FIG. 13 may automatically generate a wall. According to another exemplary embodiment, #mywall in combination with #yellow may create a yellow wall around the post using said combination of hashtags. In another exemplary embodiment, #noclips may prevent viewers from attaching clips to the post, #dc may result in a geotagged post only visible to followers in DC, etc. The exemplary utility Hashtags/Demarcations are merely exemplary, and other variations are within the scope of this disclosure.

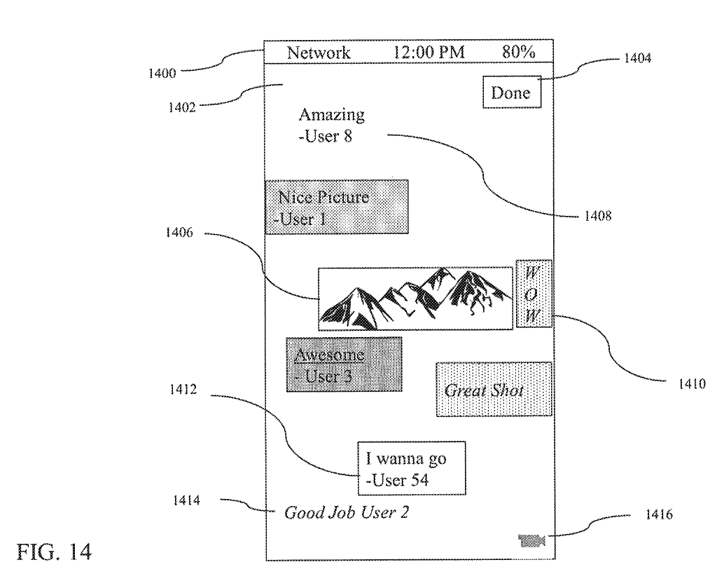

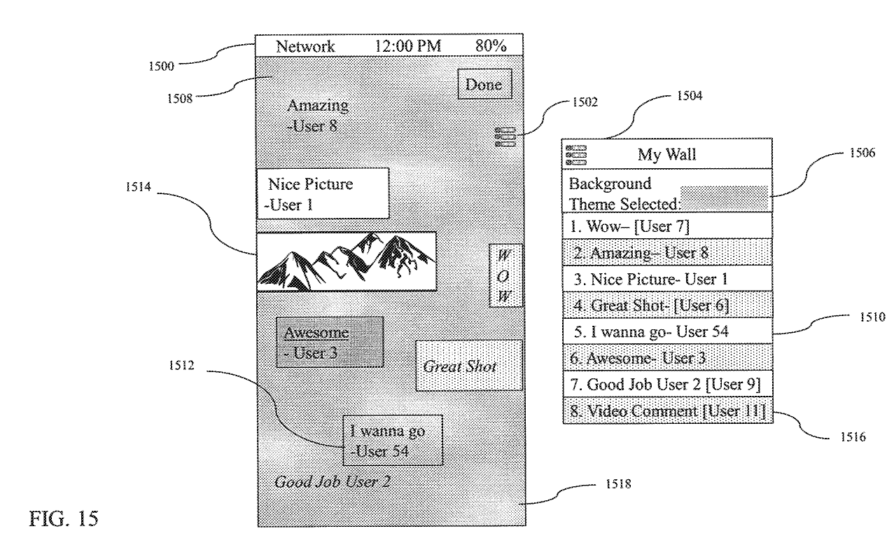

According to an exemplary embodiment, when a user clicks on a functional hashtag for #mywall 1350 for a post, the user can view the wall for the selected post as shown in FIG. 14. For instance, a functional hashtag, such as #mywall, populates a particular space. Moreover, in some embodiments, functional hashtags/demarcations may assign colors separate from normal hashtags (i.e., green instead of blue), which provide utility functions such as creating a wall when used (as shown in FIGS. 14 and 15).

FIG. 14 is a zoomed out view of a User Interface 1400 of a wall 1402 for a post 1406, surrounded by multiple wall comments (1408, 1410, 1412, 1414, and 1416) according to an exemplary embodiment. This screen may be exited in some exemplary embodiments by the user clicking “Done” 1404. In some such exemplary embodiments, the user may zoom in or out by means including but not limited to double clicking the same point, clicking a magnifying glass arrow present, or using multiple fingers to drag atop the screen in or out. In some exemplary embodiments, users posting wall comments may choose to comment without a border 1408, to hide their username from other users 1410, to edit their background color 1412, to change their font 1414 and in some such exemplary embodiments to post a photo or video comment 1416.

FIG. 15 is a zoomed out view of a User Interface 1500 for a wall for a pose 1514 from the post creators perspective according to an exemplary embodiment. In some such exemplary embodiments the post creator may toggle a menu with the click of a button on the wall 1502, that causes a menu 1504, to occupy a certain area of the User interface. The Menu 1504 may have options to edit the wall's background theme 1506, changing it to a certain animation or color 1508, view comments in an orderly fashion 1510, in some such exemplary embodiments being able to click on them causing the GUI to center and zoom in on the comment 1512, or click to play a video comment 1516, which in some such exemplary embodiments may be otherwise invisible 1518.

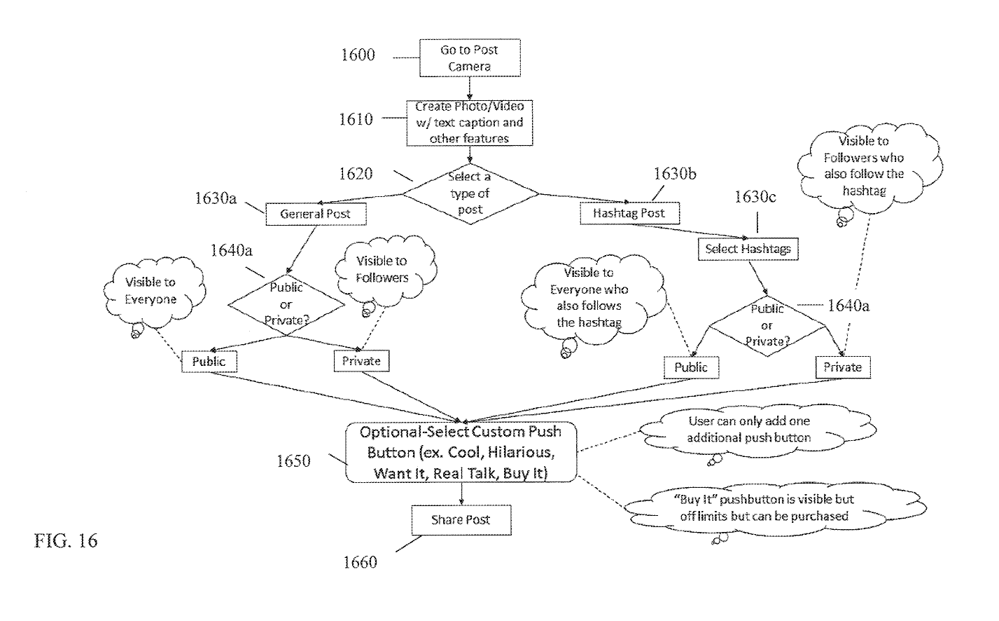

FIG. 16 is a flowchart showing the method of creating a post and assigning its hashtag and visibility options according to an exemplary embodiment. In some such exemplary embodiments, as shown in the figure, a user may create a post by selecting the Post Camera icon 1600 on the toggle bar of the user interface, creating a photo/video post with a text caption and other features 1610 or pulling the post from another social media platform, selecting a type of post 1620. The types of post may include but not limited to a General Post 1630a which will be assigned to a default hashtag such as #applicationname or hashtag post 1630b where the user selects the hashtag 1630c, choosing to create a public or private post 1640a and 1640b (public being visible to everyone following the selected hashtag [the default hashtag being followed by everyone] and private being visible only to followers who also follow the hashtag], selecting a custom push button 1650 in some such exemplary embodiments to be displayed with the post (some of which may require a purchase to be utilized, such as ‘Buy It’) and selecting to share the post 1660.

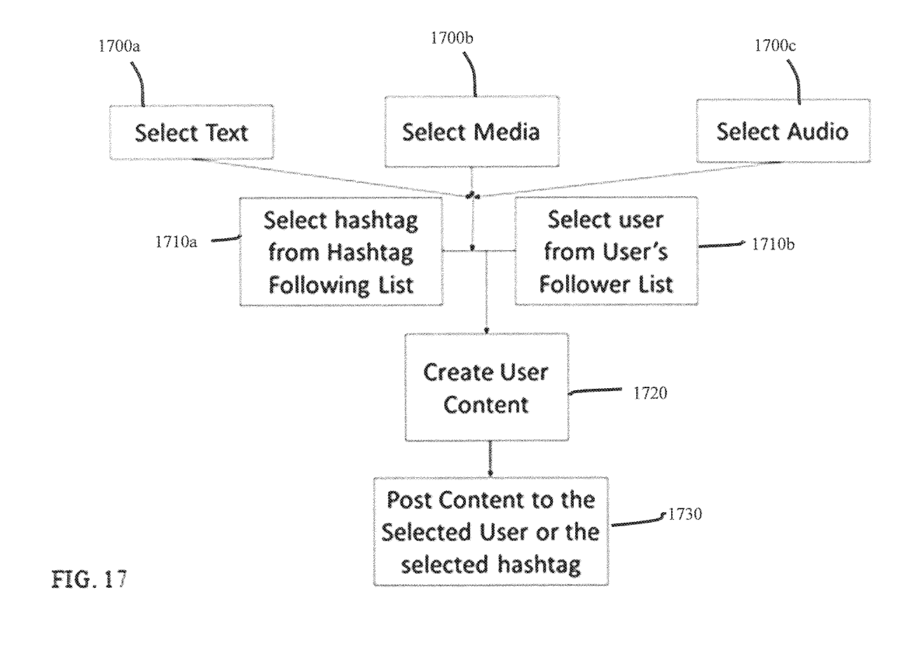

FIG. 17 is a flowchart showing the method of creating a wire and assigning its hashtag and a user to send it to. In the exemplary embodiment illustrated in the flowchart users have the option of selecting a type of wire to post including a text wire 1700a, media wire 1700b, or audio wire 1700c. The user would next select a hashtag from the list of hashtags they are following 1710a and select a user from the user's follower list 1710b, create the wire 1720 and post it 1730 to the selected user(s), selected hashtag(s) or a combination of the two. According to another exemplary embodiment, the user may selection one of a hashtag from the list of hashtags they are following or a user from the user's follower list, or both.

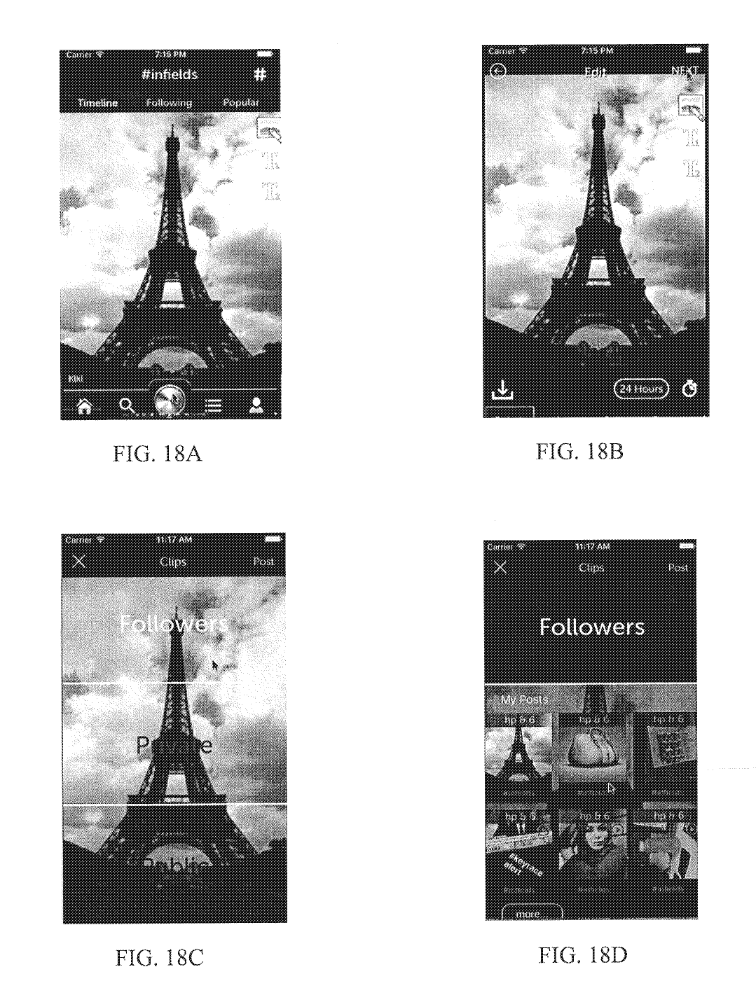

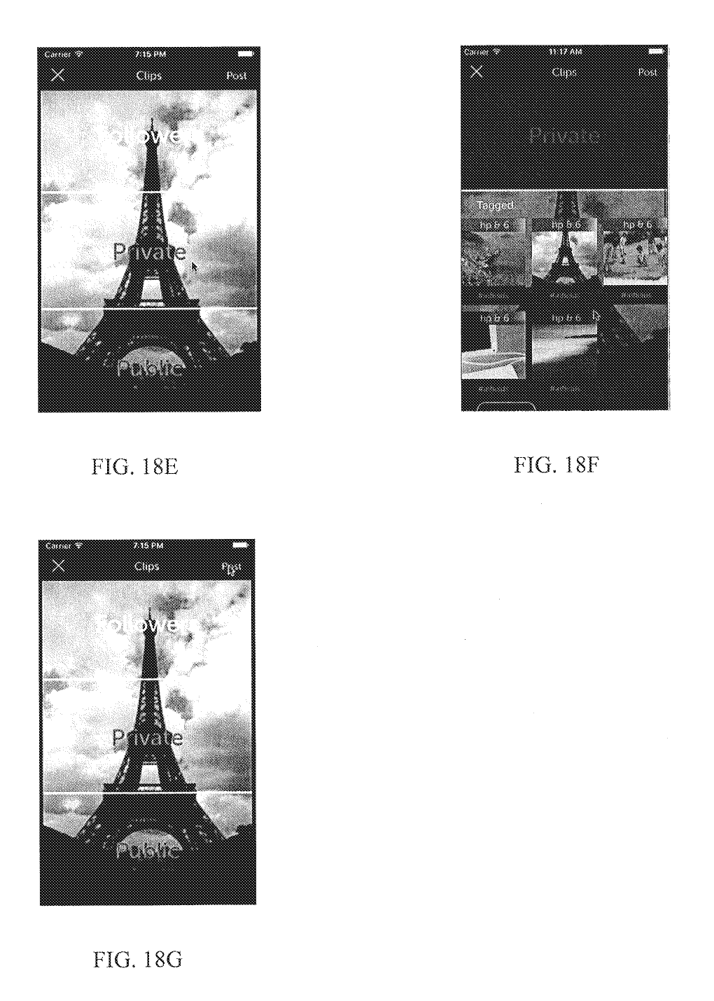

According to an exemplary embodiment illustrated in FIGS. 18A-D, a post may be created from a camera function of the user device. For instance, a simple touch of the camera button (FIG. 18A) at the bottom may lead to the clip camera (FIG. 18B). According to another exemplary embodiment, a hold of the camera button may lead to the post camera illustrated in FIG. 16. According to an exemplary embodiment, if the user chooses the clip camera option, the users are directed to clip privacy options and can select what posts to attach the clips (FIGS. 18C, 18D, 18E and 18F). In an exemplary embodiment, when a user selects “Followers” tab (FIG. 18C), an expanded attachment window with one or more posts is displayed (FIG. 18D), and the user may select one of the posts to attached the clip. In another exemplary embodiment, when a user selects “Private” tab (FIG. 18E), an expanded attachment window with one or more private posts is displayed (FIG. 18F), and the user may select one of the posts to attached the clip. According to an exemplary embodiment, the user may attach one public or follower clip and up to 10 private clips and post the clip attached to the selected post (FIG. 18G), i.e., by selecting the post function on the user interface screen of the user device. According to another exemplary embodiment, the user may attach different number of public clip, follower clip or private clip to be posted.

According to an exemplary embodiment, there may be provided scrolling edit options for a post and a clip, which would allow a user to scroll along different editing options and select buttons allowing users to select and quickly scroll through such options. For example, the buttons include but are not limited to filters, speed, and various other edit options.

According to an exemplary embodiment, there are provided automatically loaded hashtags/demarcations depending on the content the user uploads being detected. For instance, if a user is to upload a virtual reality 360 degree video, the hashtag VR may automatically be selected. In another exemplary embodiment, an augmented reality may be selected. According to an exemplary embodiment, photos and videos imported from other applications (i.e., apps), uploaded from the phone, or taken from within the app may automatically load other hashtags/demarcations which the user may choose to deselect.

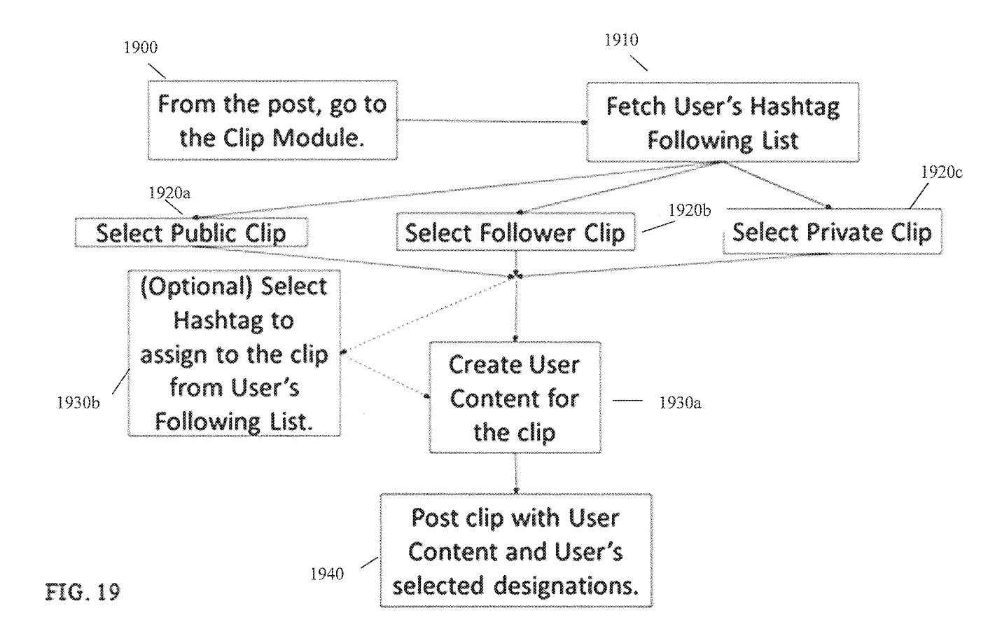

FIG. 19 is a flowchart showing the method of creating a clip, setting its visibility and possibly assigning it to a hashtag according to an exemplary embodiment. In the illustrated exemplary embodiment, a user would create a clip from within the clip module of the post of the user interface 1900, causing the user interface to send a request to the application server processor to fetch the user's hashtag following list from the database 1910, which would then be sent back to the user's mobile device and displayed on their user interface, allowing them to select a hashtag to assign the clip to in certain exemplary embodiments, in addition to the available options of selecting a public clip 1920a (which will post the clip to the general public that is capable of seeing the post), selecting a follower clip 1920b (which will post the clip only to users following the clip creator who could already see the post), or selecting a private clip 1920c (which will post the clip only to the original post creator in some exemplary embodiments) after which the user must create content for the clip 1930a before posting the clip with the content and selected designations and permissions for visibility 1940. According to another exemplary embodiment, the user may select Hashtag to assigned to the clip from the user's following list 1930b

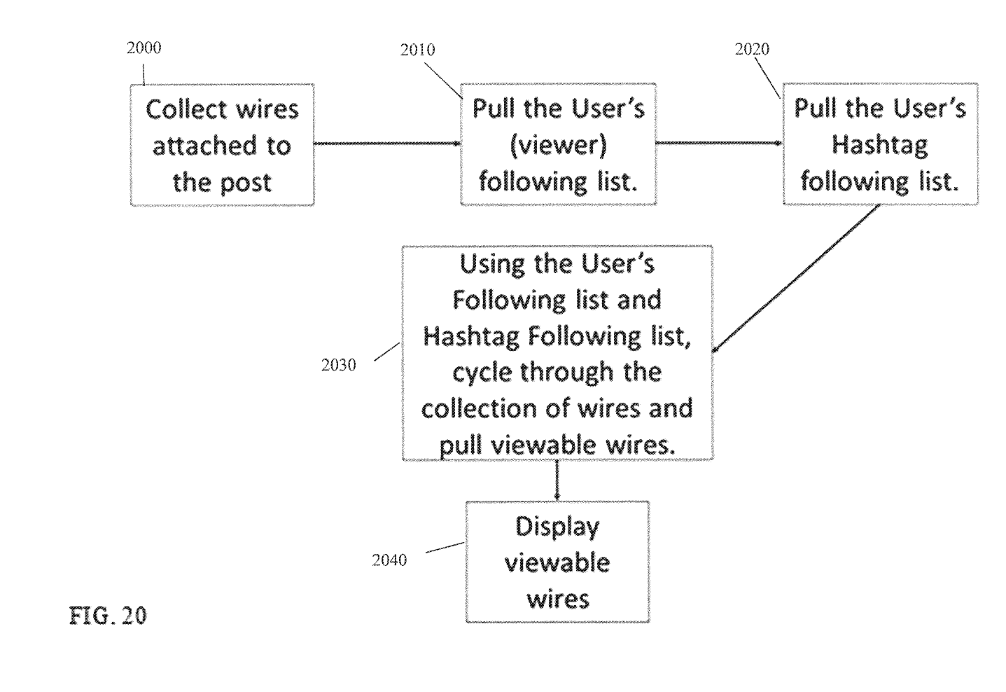

FIG. 20 is a flowchart displaying how the application user interface and server interact to make certain wires visible to the viewing user according to an exemplary embodiment. In the illustrated exemplary embodiment, when a user selects the wire menu of a post on their user interface, a signal is sent from the user's mobile device to the application server where the processor collects a list of wires attached to the post 2000, pulls the list of user's the viewing user is following from the database 2010, pulls the list of hashtags the user is following from the database 2020, cycles through the collection of wires and pulls viewable wires (those sent directly to the user or to hashtags the user is following in some exemplary embodiments) populating the database for viewable wires associated with the post 2030 and the user before sending a signal to the user's mobile device such that viewable wires will be displayed on the user interface 2040. In some such exemplary embodiments there may be limits on the amount of times a wire can be viewed before becoming inactive, or the duration that a wire will be visible for.

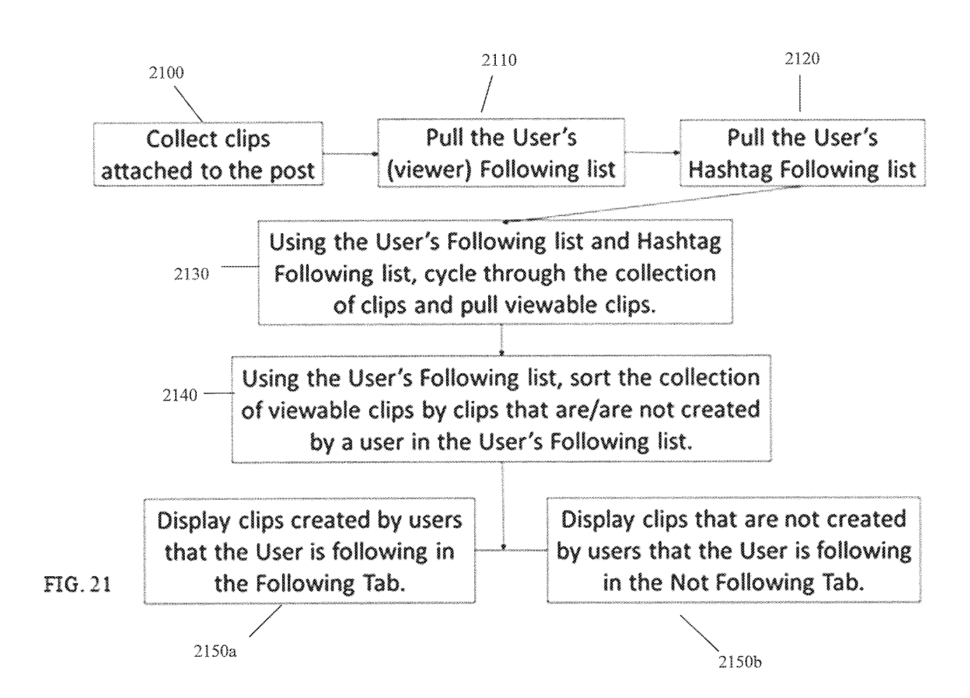

FIG. 21 is a flowchart displaying how the application user interface and server interact to make certain clips visible to the viewing user according to an exemplary embodiment. In the illustrated exemplary embodiment, when a user selects the clip menu of a post on their user interface, a signal is sent from the user's mobile device to the application server where the processor collects a list of clips attached to the post 2100, pulls the list of user's the viewing user is following from the database 2110, pulls the list of hashtags the user is following from the database 2120, cycles through the collection of clips and pulls viewable clips 2130 populating the database for viewable clips associated with the post and the user sorting them by clips from users the user is following and clips from users the user is not following 2140 before sending a signal to the user's mobile device such that viewable clips will be displayed on the user interface. According to an exemplary embodiment, the viewable clips may be displayed under either a first sub-menu 2150a or a second sub-menu 2150b.

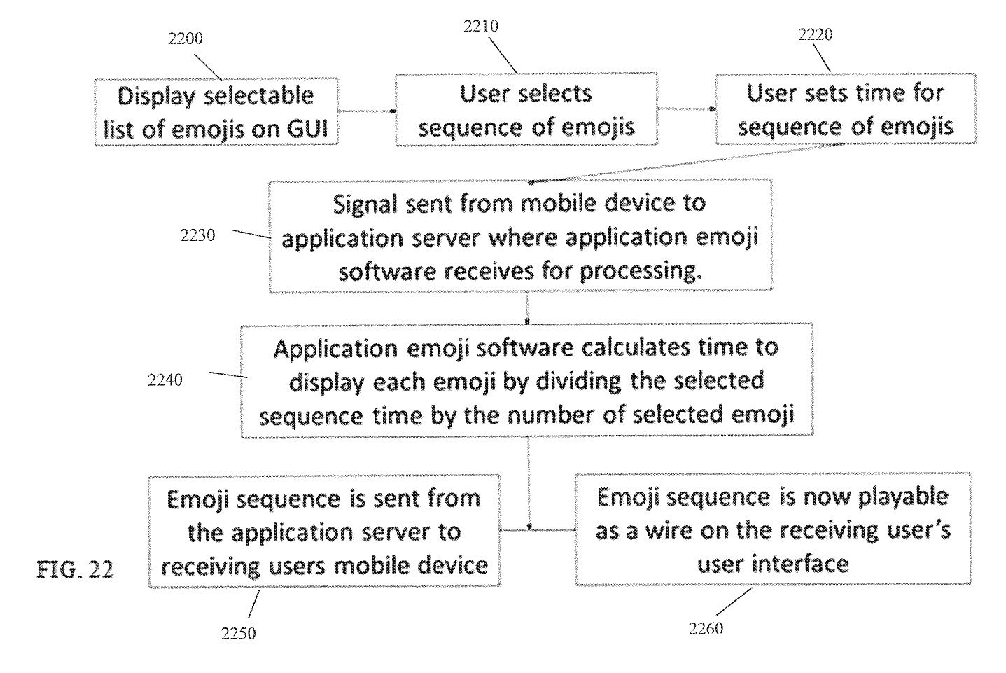

FIG. 22 is a flowchart illustrating an exemplary embodiment of how the users may utilize an emoji stream module including pulling up a menu 2200 to create textual emoticons from within their user interface to select a sequence of emojis 2210 and a time to display the sequence of emojis for 2120, their mobile device sending a signal 2230, containing some indication of the selected emojis and timing, to the application server for processing. While there, the timing of each individual emoji will be calculated as an average as the total time selected for the sequence 2240 and sorted to the database as the sequence is sent back to a receiving user's mobile device 2250 where it may be viewed in the receiving user's user interface as a video displaying each emoticon in the emoji sequence in order 2260. In such an exemplary embodiment, the emoji stream would be considered an emoji wire. There may exist other exemplary embodiments for emoji streams such as each individual emoticon displaying for a set period of time (perhaps half a second) such that it is unnecessary for each user to select the amount of time for the sequence, as it will depend solely on the number of emoticons selected for the sequence (for example a selection of 9 emoticons would ultimately result in an emoji stream that plays for 4.5 seconds in such an embodiment). If a user wishes to select an emoticon for longer than 0.5 seconds in such an embodiment, he may select the same emoticon twice in a row, causing it to display for a full second. In other exemplary embodiments users may be limited to the number of emojis they can use in a stream. In yet other exemplary embodiments emoji streams maybe used to create additional user content including but not limited to posts or clips.

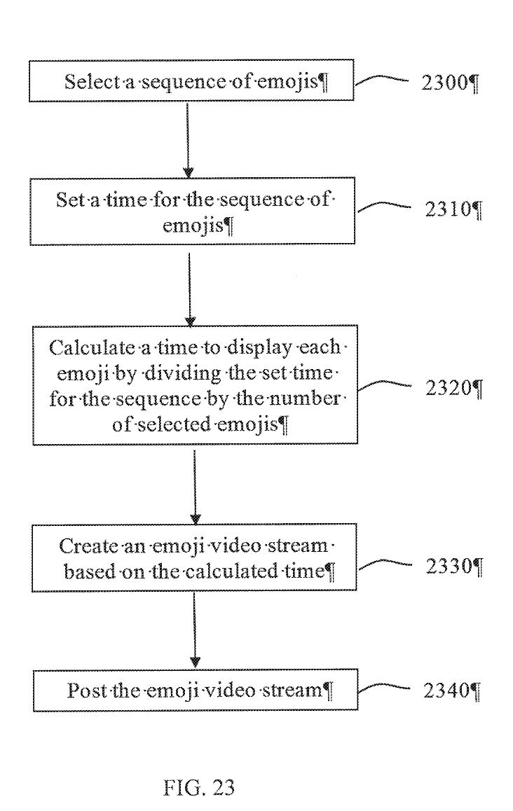

According to another exemplary embodiment illustrated in FIG. 23, the user may select a sequence of emojis 2300, set a time for the sequence of emojis 2310, calculate a time to display each emoji by dividing the set time for the sequence by the number of selected emojis 2320, create an emoji video stream based on the calculated time 2330 and post the emoji video stream 2340.

According to an exemplary embodiment, the emoji stream may be saved an animated gif or a video. For instance, a user may select a button to save the emoji stream as an animated gif file or a video file, which may be posted.

The exemplary embodiments described herein may be implemented using hardware components, software components, or a combination thereof. The hardware components may include computer processing unit (CPU), one or more processors, one or more programmable circuits, or the like, and the combination thereof. The software components may include a computer program, a piece of code, an instruction, or some combination thereof, to independently or collectively instruct the processing device to operate as desired or configure the processing device to operate as desired.

While this disclosure includes exemplary embodiments, it will be apparent to one of ordinary skill in the art that various changes in form and details may be made in these exemplary embodiments without departing from the spirit and scope of the claims and their equivalents.

What is claimed is:

1. An apparatus comprising:
at least one memory operable to store program code;
at least one hardware processor operable to read the program code and operate as instructed by the program code, the program code including:
post receiving code configured to cause the at least one hardware processor to receive a post from a first user terminal associated with a first user, the post including at least one demarcation followed by a word or a phrase;
extracting code configured to cause the at least one hardware processor to extract the at least one demarcation along with the word or the phrase;
determining code configured to cause the at least one hardware processor to determine at least one second user who is following the word or the phrase; and
output code configured to cause the at least one hardware processor to display the post including the at least one demarcation to a second user terminal of the second user.

2. The apparatus in claim 1 further comprising a search feature for social entities and a follow function that when selected establishes a follow relationship with the selected social entity, thereby making posts assigned to said social entity visible.

3. The apparatus of claim 2 further comprising a search feature for users and a follow function that when selected establishes a follow relationship with the selected user thereby making posts assigned by the followed user to any social entity the user is following visible.

4. The apparatus of claim 3 further comprising a following tab as described in the specification.

5. The apparatus of claim 4 further comprising a function for users to attach clips to posts as described in the specification.

6. The apparatus of claim 3 further comprising a send wire function associated with each post as described in the specification.

7. The apparatus of claim 3 further comprising a function for users to tag one another to a post, thereby allowing a tagged user to view and edit the post as if they were the original creator.

8. The apparatus of claim 3 further comprising a timeline where users may select a finite number of social entities to appear on said timeline.

9. The apparatus of claim 3 further comprising a function to create, post to and follow private social entities.

10. The apparatus of claim 3 further comprising a function to create personal social entities.

11. The apparatus of claim 3 further comprising a function to create posts visible only to users within or entering a geolocation identified region.

12. The apparatus of claim 3 further comprising a token system wherein the expenditure of virtual tokens is required for users to tag one another or create geolocation based posts.

13. The apparatus of claim 3 further comprising the ability of users to create demarcations on posts created by other users, said demarcations comprising further user created information that is visible when selected by other users.

14. The apparatus of claim 13 further comprising the ability of users to create demarcations associated with a particular time and area on video posts.

15. The apparatus of claim 3 further comprising a function for users to associate their profiles from other social networking platforms and pull posts related to a user defined social entity, into the application.

16. The apparatus of claim 1 further comprising a function to limit users to the creation of a specific quantity of posts, such that when said quantity is exceeded, the oldest post will automatically be deleted to create a space for the new post.

17. An apparatus comprising:
at least one memory operable to store program code;
at least one hardware processor operable to read the program code and operate as instructed by the program code, the program code including:
emoji receiving code configured to cause the at least one hardware processor to receive a plurality of emojis input by a user;
extracting code configured to cause the at least one hardware processor to extract each of the plurality of emojis based on a predetermined rule;
generating code configured to cause the at least one hardware processor to generate a video stream including the plurality of emojis; and
output code configured to cause the at least one hardware processor to output the video stream of emojis.

18. The apparatus of claim 17 further comprising a function for users to limit the length of time for each emoji.

19. An apparatus comprising:
at least one memory operable to store program code;
at least one hardware processor operable to read the program code and operate as instructed by the program code, the program code including:
post receiving code configured to cause the at least one hardware processor to receive a post from a first user terminal associated with a first user, the post including first content and a selection of one or more second users;
group creating code configured to cause the at least one hardware processor to create a group associated with the post, the group comprising the first user and the one or more second users; and
access granting code configured to cause the at least one hardware processor to grant each member of the group access to the first content of the post.

20. The apparatus according to claim 19, wherein, the access granting code is further configured to cause the at least one hardware processor to permit one or more members of the group access to add second first content to the post.
